(19) United States
(12) Patent Application Publication
(10) Pub. No.: US 2025/0058644 A1
(43) Pub. Date: Feb. 20, 2025

(54) METHOD OF CONTROLLING TORQUE OF AN ELECTRIC VEHICLE DRIVING SYSTEM

(71) Applicants: HYUNDAI MOTOR COMPANY, Seoul (KR); KIA CORPORATION, Seoul (KR)

(72) Inventors: Ji Won Oh, Hwaseong-si (KR); Ho Wook Lee, Seoul (KR)

(73) Assignees: HYUNDAI MOTOR COMPANY, Seoul (KR); KIA CORPORATION, Seoul (KR)

(21) Appl. No.: 18/390,985

(22) Filed: Dec. 20, 2023

(30) Foreign Application Priority Data
Aug. 14, 2023 (KR) 10-2023-0106087

(51) Int. Cl. B60L 15/20; B60L 7/18

(52) U.S. Cl. CPC B60L 15/20; B60L 7/18; B60L 2240/463; B60L 2250/28

(57) ABSTRACT

A method of controlling a torque of a driving system of an electric vehicle includes determining whether a brake pedal is additionally applied at a time when only an acceleration pedal is applied. The method also includes determining an amount of a braking torque corresponding to an amount of the applied brake pedal amount. The method further includes reflecting the amount of the braking torque in one or both of a front wheel torque command and a rear wheel torque command selected according to information indicating a current vehicle driving state and front and rear wheel torque distribution states. The method additionally includes controlling a front wheel motor and a rear wheel motor according to the front wheel torque command and the rear wheel torque command.

### CROSS-REFERENCE TO RELATED APPLICATION

This application claims, under 35 U.S.C. § 119(a), the benefit of and priority to Korean Patent Application No. 10-2023-0106087, filed on Aug. 14, 2023, the entire contents of which are incorporated herein by reference.

### TECHNICAL FIELD

The present disclosure relates to a method of controlling a torque of an electric vehicle driving system, and more specifically, to a method of generating and controlling a torque of a driving system when an accelerator pedal and a brake pedal are simultaneously applied in an electric vehicle.

### BACKGROUND

A driver's input for acceleration/deceleration in a vehicle is typically provided via an accelerator pedal or a brake pedal by a driver, i.e., a driver's manipulation of the accelerator pedal or the brake pedal.

Typically, the driver presses and manipulates the accelerator pedal and the brake pedal using the driver's foot. Such input (pedal input) provided by the driver pressing the accelerator pedal or the brake pedal using the driver's foot is required during driving of the vehicle.

Accordingly, the driver adjusts acceleration and deceleration of the vehicle selectively using two pedals. A typical driver manipulates both the accelerator pedal and the brake pedal using one foot when driving the vehicle. Generally, manipulating the pedal using two feet is not recommended due to various reasons such as convenience, safety, and durability.

When two feet are used, there may be a situation in which the driver steps on the accelerator pedal and the brake pedal using two feet at the same time. In the case of electric vehicles, care should be taken because an overheating phenomenon of a driving system may occur when the driver steps on the accelerator pedal and the brake pedal at the same time.

A method of regarding the accelerator pedal as being not applied when two pedals are simultaneously applied while the vehicle travels, which is called a brake override function, is widely used.

However, for special purposes, there is a case in which simultaneous application of two pedals should be allowed unlike the above-described general method. For example, simultaneous application of two pedals should be allowed for maximizing turning performance when the vehicle travels on a track of a circuit.

More specifically, in order to reduce a time delay that is present between the release of the accelerator pedal and the application of the brake pedal, or a time delay between the release of the brake pedal and the application of the accelerator pedal, when a vehicle travels on the track, there is a case in which the two pedals are blended so that the inputs of the two pedals using two feet overlap.

In addition, in order to prevent or mitigate understeer of the vehicle when the accelerator pedal is applied during turning, there is a case in which the brake pedal is simultaneously applied while a state in which the accelerator pedal is applied is maintained.

This behavior is based on two principles reducing the understeer. The first principle is based on neutralization of magnitudes of longitudinal forces applied to tires of front wheels. The second principle is based on increasing transmission of a load forward from the vehicle by increasing a deceleration force.

A first factor is related to the characteristics of the tires. In order to reduce the understeer, lateral forces of the front wheels should be increased. The lateral forces of the front wheels may be increased as the longitudinal forces of the front wheels may be maintained close to zero.

In addition, an effective method for extending the limitations of the lateral forces of the front wheels is to increase a vertical load applied to the front wheels, which may be obtained through the forward transmission of the load.

Conventionally, in order to secure the durability and safety of the driving system of the electric vehicle, when the brake pedal is applied while the accelerator pedal is applied, the brake override function is operated so that a braking force is applied and, at the same time, a driving force generated by a motor is removed.

In this case, as a friction braking force forcibly blocks the driving of the motor, it is possible to prevent the occurrence of thermodynamic damage to the motor and a braking system depending on a vehicle speed.

However, this method is undesirable because traveling performance and turning stability of the vehicle may be significantly degraded due to momentary loss of the driving force and the transmission of the load caused by braking when the vehicle turns on the track.

### SUMMARY

Therefore, it is necessary to allow the simultaneous application of the accelerator pedal and the brake pedal for a performance mode of an electric vehicle for a special purpose as described above and develop an operation strategy thereof, but until now, allowing the simultaneous application of the accelerator pedal and the brake pedal and developing a strategy of controlling a torque of a driving system accordingly are not yet considered.

The present disclosure has been made in efforts to solve the above problems and is directed to providing a method of controlling a torque of a driving system when an accelerator pedal and a brake pedal are simultaneously applied as a performance mode-dedicated strategy.

More specifically, embodiments of the present disclosure provide a control method of generating a combination of front and rear wheel motor torque commands and a friction braking torque command, which may generate a torque of a driving system expected by a driver according to simultaneous input values of an accelerator pedal and a brake pedal, in real time.

The objects of the present disclosure are not limited to the above-described object. Other objects that are not mentioned should be able to be clearly understood by those having ordinary skill in the art to which the present disclosure pertains from the following description.

In an embodiment of the present disclosure, a method of controlling a torque of a driving system of an electric vehicle is provided. The method includes determining, by a controller, whether a brake pedal is additionally applied at a time when only an acceleration pedal is applied. The method also includes determining, by the controller, an amount of a braking torque corresponding to an amount of the applied brake pedal amount when it is determined to be a pedal simultaneous application state in which the brake pedal is additionally applied. The method further includes reflecting, by the controller, the determined amount of the braking torque in one or both of a front wheel torque command and a rear wheel torque command selected according to information indicating a current vehicle driving state and front and rear wheel torque distribution states. The method additionally includes controlling, according to the front wheel torque command and the rear wheel torque command determined through the reflecting of the amount of the braking torque, a front wheel motor configured to drive a front wheel of the electric vehicle and a rear wheel motor configured to drive a rear wheel of the electric vehicle.

According to the method of controlling the torque of the driving system of the electric vehicle according to embodiments of the present disclosure, it is possible to control the torque of the driving system when the accelerator pedal and the brake pedal are simultaneously applied as the performance mode-dedicated strategy.

In addition, it is possible to generate the torque of the driving system of the vehicle expected by the driver through a combination of the front and rear wheel motor torque commands and the friction braking torque command when the pedals are simultaneously applied.

In addition, since the brake override function is operated when the vehicle travels on the track, it is possible to solve the conventional problems in which the behavior of the vehicle expected by the driver was not possible, and to optimize the lap time when the vehicle travels on the track.

In addition, it is possible to prevent the degradation of the motor and the brake, the degradation of traveling stability, and the like, which may occur when the brake override function is arbitrarily released.

It should be understood that the terms “automotive”, “vehicular”, and other similar term as used herein is inclusive of motor vehicles in general. Such motor vehicles may encompass passenger automobiles including sports utility vehicles (operation SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, a vehicle that is both gasoline-powered and electric-powered.

The above and other features of the disclosure are discussed below.

### BRIEF DESCRIPTION OF THE DRAWINGS

The above and other features of the present disclosure are described in detail below with reference to certain examples thereof illustrated in the accompanying drawings, which are given herein below by way of illustration only, and thus are not limitative of the present disclosure, and wherein:

FIG. 1 is a block diagram illustrating a configuration of an apparatus for performing a process of controlling a torque of a driving system, according to an embodiment of the present disclosure;

FIGS. 2 and 3 are flowcharts illustrating a process of controlling a torque of a driving system, according to an embodiment of the present disclosure; and

FIG. 4 is a view illustrating a torque control state, according to an embodiment of the present disclosure.

It should be understood that the accompanying drawings are not necessarily to scale, presenting a somewhat simplified representation of various features illustrative of the basic principles of the disclosure. The specific design features of embodiments of the present disclosure, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the accompanying drawings. Specific structural or functional descriptions presented in the embodiments of the present disclosure are merely illustrative for the purpose of describing embodiments according to the concept of the present disclosure. The embodiments according to the concept of the present disclosure may be implemented in various forms. In addition, the disclosure should not be construed as being limited by the embodiments described in the specification. It should be understood that the disclosure includes all modifications, equivalents, or substitutes included in the spirit and technical scope of the present disclosure.

In the present disclosure, terms such as first and/or second may be used to describe various components, but the components are not limited by the terms. The terms are used only for the purpose of distinguishing one component from another without departing from the scope of the present disclosure according to the concept of the present disclosure. For example, a first component may be referred to as a second component, and similarly, the second component may also be referred to as the first component.

When a certain component is described as being “connected” or “coupled” to another component, it should be understood that the certain component may be directly connected or coupled to another component or other components may also be disposed therebetween. On the other hand, when a certain component is described as being “directly connected” or “directly coupled” to another component, it should be understood that other components are not disposed therebetween. Other expressions for describing the relationship between components, such as “between” and “directly between” or “adjacent to” and “directly adjacent to”, should be construed in the same manner.

The same reference numbers denote the same components throughout the specification. Terms used in the specification are for describing the embodiments and are not intended to limit the present disclosure. In the specification, the singular form also includes the plural form unless specifically stated in the phrase or otherwise clearly specified in context. As used herein, “comprises” and/or “comprising” means that the stated component, step, operation, and/or element do not preclude the presence of addition of one or more other components, steps, operations, and/or elements. When a component, device, element, or the like of the present disclosure is described as having a purpose or performing an operation, function, or the like, the component, device, or element should be considered herein as being “configured to” meet that purpose or perform that operation or function.

The present disclosure relates to a method of controlling a torque of a driving system of an electric vehicle for a high performance mode or the like, and particularly, to a method of controlling a torque of a driving system when an accelerator pedal and a brake pedal (deceleration pedal) are simultaneously applied.

In addition, the present disclosure is directed to providing a control method of generating a combination of front and rear wheel motor torque commands and a friction braking torque command, which may generate a torque of a driving system expected by a driver according to simultaneous input values of an accelerator pedal and a brake pedal, in real time.

Embodiment of the present disclosure are based on a principle in which a driver's demand may be reflected when a vehicle travels on a track of a circuit while not causing a serious durability problem upon controlling the torque based on a value of the entire required torque (total required torques of front and rear wheels), which is a total torque before the torque is distributed to a front wheel torque and a rear wheel torque, even when an accelerator pedal and a brake pedal are simultaneously applied.

Since the simultaneous application of a motor torque and hydraulic braking in a vehicle causes a safety problem and a durability problem, it is possible to solve the problem when the motor itself may generate the effect of applying the hydraulic braking.

In consideration of this point, the present disclosure provides a method capable of implementing a driver's demand through a torque in real time by considering an amount of the applied accelerator pedal and an amount of the applied brake pedal.

The effect caused by inputting the brake pedal in a state of maintaining the input of the accelerator pedal is subtracting a torque determined by an amount of the input brake pedal. Accordingly, the present disclosure provides a method of determining a subtraction priority in consideration of at which time point and from which motor it is effective to subtract the torque.

As described above, enabling the simultaneous input of the pedals is a special situation such as traveling on the track, and more specifically, it is necessary to increase the responsiveness of torque control and generate the effect of reducing understeer. Embodiments of the present disclosure may use the following two items to reduce the understeer.
Increasing the vertical load acting on the front wheel side due to the transmission of the load forward from the vehicle, and
Decreasing an amount of a driving force applied to the front wheels in consideration of the characteristics of a friction circle of a tire.

The control method according to embodiments of the present disclosure is described in detail below with reference to the accompanying drawings.

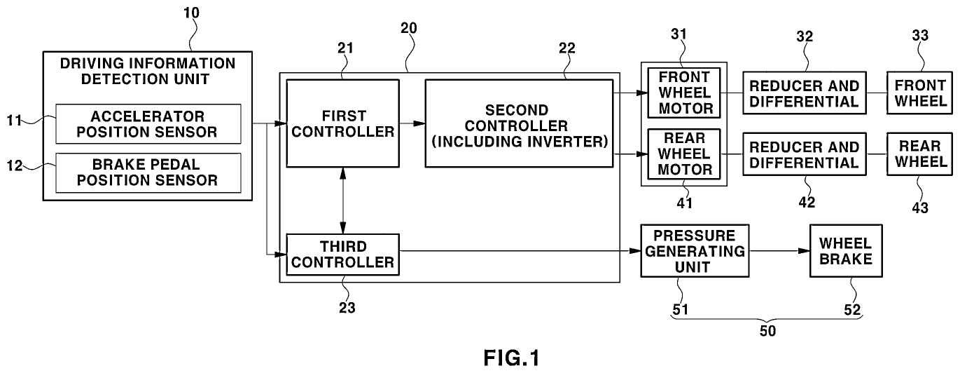

FIG. 1 is a block diagram illustrating a configuration of an apparatus for performing a process of controlling a torque of a driving system, according to an embodiment of the present disclosure.

Embodiments of the present disclosure may be applied to a vehicle in which front wheels 33 and rear wheels 43 are each driven by an independent driving device. For example, embodiments of the present disclosure may be applied to a vehicle equipped with a front wheel driving device for applying a torque to the front wheels 33 and a rear wheel driving device for applying a torque to the rear wheels 43. The front wheels 33 and the rear wheels 43 may be driving wheels connected to one of the driving devices to transmit power.

In addition, embodiments of the present disclosure may be applied to a vehicle in which both the front wheel driving device and the rear wheel driving device are motors. In the following description, a motor 31, which is the front wheel driving device, is referred to as “front wheel motor,” and a motor 41, which is the rear wheel driving device, is referred to as “rear wheel motor.”

As illustrated, the front wheel motor 31 is connected to the front wheels 33 through a reducer and a differential 32 to transmit power, and the rear wheel motor 41 is connected to the rear wheels 43 through a reducer and a differential 42 to transmit power.

In embodiments of the present disclosure, a driving torque and a driving torque command are acceleration directional torques accelerating a vehicle and a motor driving directional torque, which may be defined as torques having a positive (+) value and a positive (+) direction. On the other hand, a braking torque and a braking torque command are deceleration directional torques decelerating a vehicle, which may be defined as torques having a negative (−) value and a negative (−) direction.

In addition, in the following description, the front wheel torque command and the rear wheel torque command are torque commands for each motor (the front wheel motor 31 and the rear wheel motor 41) for driving the vehicle, i.e., a vehicle acceleration directional torque and a rear wheel motor torque command, and among the motor torques, the vehicle acceleration directional torque and the motor driving directional torque are positive (+) directional torques, i.e., torques having a positive (+) value.

In addition, the braking torque includes a regenerative braking torque generated by the front wheel motor 31 and the rear wheel motor 41 and a friction braking torque generated by a friction braking device 50. Both the regenerative braking torque and the friction braking torque are negative (−) directional torques, i.e., torques having a negative (−) value because they are deceleration directional torques.

When the torque values of the front wheel torque command and the rear wheel torque command, which are torque commands for the motors 31 and 41, indicate a negative (−) value, the commands are the regenerative braking torque commands for the corresponding motor. The front wheel motor torque and the rear wheel motor torque having the negative (−) value are the deceleration directional and regenerative directional torques.

In addition, when the torque values of the front wheel torque command and the rear wheel torque command indicate the positive (+) value, the commands are the driving torque commands for the corresponding motor, and the front wheel motor torque and the rear wheel motor torque having the positive (+) value are the acceleration directional and driving directional torques.

Separately from the regenerative braking torque command, which is the front wheel torque command and the rear wheel torque command having the negative (−) value, the friction braking torque command is a command for controlling the friction braking of the vehicle. The friction braking torque command is a command for the friction braking device 50. The friction braking device 50 may be a hydraulic braking device. Since the torque of the friction braking torque command is also the braking torque, the torque is the deceleration directional torque and is the negative (−) directional torque, i.e., the torque having the negative (−) value.

In the following description, “applying” a pedal means pressing and manipulating the corresponding pedal. Further, in the present disclosure, “applying” the pedal, “input” the pedal, and “manipulating” the pedal by a driver may all be understood in the same sense. Conversely, “releasing” the pedal means allowing the corresponding pedal to become a non-manipulated state in which the pedal is not pressed.

In addition, “ON” of the pedal means a state in which the corresponding pedal is pressed and applied. In other words, “ON” of the pedal is a state in which the pedal is input. “OFF” of the pedal means the non-manipulated and released state in which the corresponding pedal is not pressed and is a state in which the pedal is not input (a pedal input value is zero).

In embodiments of the present disclosure, a state in which an accelerator pedal and a brake pedal are simultaneously applied is a state in which the accelerator pedal and the brake pedal are simultaneously manipulated. Accordingly, a state in which an accelerator pedal and a brake pedal are simultaneously applied is a state in which the accelerator pedal is ON and the brake pedal is also ON. For example, when a driver applies the brake pedal in a state of applying the accelerator pedal while driving a vehicle, this becomes a state in which the two pedals are simultaneously applied.

The ON of the pedal and the OFF of the pedal may be detected by sensors 11 and 12 mounted on the corresponding pedals. Information on ON/OFF of the accelerator pedal and an accelerator pedal input value (amount of the applied accelerator pedal) by the driver may be acquired from a signal of a accelerator position sensor (APS) 11. Information on ON/OFF of the brake pedal and a brake pedal input value (amount of the applied brake pedal) by the driver may be acquired from a signal of a brake pedal position sensor (BPS) 12.

In embodiments of the present disclosure, a driving system of a vehicle includes driving elements such as a motor and driving wheels for driving the vehicle, driving shafts between the motor and the driving wheels, reducers, differentials, axles, etc. In embodiments of the present disclosure, the driving system of the vehicle includes a front wheel side driving system and a rear wheel side driving system. The front wheel side driving system includes the front wheel motor 31, the front wheels 33, the driving shaft (not illustrated) between the front wheel motor 31 and the front wheel 33, a reducer, the differential 32, and an axle (not illustrated).

In addition, the rear wheel side driving system includes the rear wheel motor 41, the rear wheels 43, a driving shaft (not illustrated) between the rear wheel motor 41 and the rear wheel 43, a reducer, the differential 42, and an axle.

Therefore, torques output from the front wheel motor 31 and the rear wheel motor 41 in each driving system may be transmitted to the front wheels 33 and the rear wheels 43 through the driving system elements such as the driving shafts, the reducers, the differentials 32 and 42, and axles.

In addition, although not illustrated in FIG. 1, a battery is connected to the front wheel motor 31 and the rear wheel motor 41 via an inverter to be charged and discharged. The inverter may include a front wheel inverter (not illustrated) for driving and controlling the front wheel motor 31 and a rear wheel inverter (not illustrated) for driving and controlling the rear wheel motor 41.

In an electric vehicle, operations (driving and regeneration) of the front wheel motor 31 and the rear wheel motor 41 are controlled according to torque commands generated by a controller 20. The controller 20 determines a required torque according to a vehicle driving state. The controller 20 generates the entire torque command (required torque command) based on the required torque. The controller then determines torque commands for each motor 31 and 41, i.e., the front wheel torque command and the rear wheel torque command from the entire torque command.

In addition, the controller 20 controls the operations of the front wheel motor 31 and the rear wheel motor 41 through the inverters based on the front wheel torque command and the rear wheel torque command. As described above, the front wheel torque command and the rear wheel torque command are defined as the driving torque commands, which are the acceleration directional and driving directional torque commands, when the commands have positive (+) value. the front wheel torque command and the rear wheel torque command are defined as the regenerative braking torque commands, which are the deceleration directional and regeneration directional torques, when the commands have negative (−) values.

The entire torque command may be a torque command (required torque command) for generating a required torque necessary for the vehicle to travel through the motors 31 and 41. The friction braking device 50 and may be a torque command before a rear wheel torque distribution is performed (pre-distribution torque command).

In addition, the entire torque command is a torque command (total torque command) adding the front wheel torque command and the rear wheel torque command or a torque command adding the front wheel torque command, the rear wheel torque command, and the friction braking torque command. In this regard, the entire torque command may be the required torque command, the pre-distribution torque command, and the total torque command.

In embodiments of the present disclosure, the controller 20 may include a first controller 21. The first controller 21 may determine the required torque necessary for the vehicle to travel based on a driving input value of a driver or receiving the required torque from another controller such as an advanced driver assistance system (ADAS). The first controller 21 may generate and output the front wheel torque command and the rear wheel torque command, which are torque commands for each motor (for each axle), based on the required torque. The controller 20 may also include a second controller 22 that may control the operations of the front wheel motor 31 and the rear wheel motor 41 according to a final torque command input from the first controller 21. The controller 20 may further include a third controller 23 that may control the operation of the friction braking device 50 through cooperation control with the first controller 21.

The first controller 21 may be a vehicle control unit (VCU) for determining and generating the entire torque command necessary for the vehicle to travel in general vehicles. Since a method and a process of determining a torque command in a vehicle are well-known to those having ordinary skill in the art, a detailed description thereof has been omitted.

The first controller 21 may determine the front wheel torque command and the rear wheel torque command from the entire torque command. In an example, the front wheel torque command and the rear wheel torque command include all motor torque commands as torque commands for each axle, where the front wheel torque command is a torque command for the front wheel motor 31 and the rear wheel torque command is a torque command for the rear wheel motor 41.

When the front wheel torque command and the rear wheel torque command are output from the first controller 21, the second controller 22 receives the front wheel torque command and the rear wheel torque command and controls the operations of the front wheel motor 31 and the rear wheel motor 41 through the front wheel inverter and the rear wheel inverter.

Therefore, a torque output by the front wheel motor 31 is applied to the front wheels 33 through the reducer and the differential 32 of the front wheel side driving system. Further, a torque output by the rear wheel motor 41 is applied to the rear wheels 43 through the reducer and the differential 42 of the rear wheel side driving system.

The second controller 22 may be a general motor control unit (MCU) for controlling an operation of a driving motor through an inverter according to a torque command output by the VCU in an electric vehicle.

In embodiments of the present disclosure, vehicle driving information, such as a driving input value of a driver, input to the controller 20 is information indicating a vehicle driving state. The vehicle driving information may include sensor detection information detected by a driving information detection unit 10 and input to the controller 20 via a vehicle network.

The driving information detection unit 10 may include the APS 11 for detecting an accelerator pedal input value (APS value, %) of the driver, the BPS 12 for detecting a brake pedal input value (BPS value, %) of the driver, a sensor (not illustrated) for detecting a speed of the driving system, and a sensor (not illustrated) for detecting a vehicle speed.

The speed of the driving system may be rotating speeds of the front wheel motor 31 and the rear wheel motor 41, which are the driving motors, or rotating speeds (wheel speeds) of the driving wheels 33 and 43. In this case, the sensor for detecting the speed of the driving system may be a sensor for detecting the rotating speed of each of the motors 31 and 41, which may be a general resolver for detecting a position of a rotor of the motor. Alternatively, the sensor for detecting the speed of the driving system may be a typical wheel speed sensor for detecting the rotating speeds (wheel speeds) of the driving wheels 33 and 43.

In addition, the sensor for detecting the vehicle speed may also be the wheel speed sensor. Since obtaining the vehicle speed information from the signal from the wheel speed sensor is a well-known technique to those having ordinary skill in the art, a detailed description thereof has been omitted.

The vehicle driving information for determining and generating the required torque and the torque command from the controller 20 is detected by the driving information detection unit 10. The APS value (%) of the driver, the BPS value (%) of the driver, the rotating speeds of the motors 31 and 41, the rotating speeds of the driving wheels 33 and 43, the vehicle speed, or the like may be selectively used.

Among the vehicle driving information, the APS value and the BPS value, which are the driving input values of the driver, may be considered as the driving input information of the driver. Further, the rotating speeds of the motors 31 and 41, the rotating speeds of the driving wheels 33 and 43, and the vehicle speed, which are detected by the driving information detection unit 10, may be considered as the vehicle state information.

In addition, the vehicle driving information may include information determined by the controller 20 itself in a broad sense. The vehicle driving information may also include information (e.g., required torque information) input to the controller 20 from another controller (e.g., a controller of the ADAS) in the vehicle via the vehicle network.

Referring to FIG. 1, a friction braking device 50 of the vehicle may be a front wheel friction braking device for applying a friction braking torque to the front wheels 31 or a rear wheel friction braking device for applying the friction braking torque to the rear wheels 43.

The friction braking device 50 may be a general hydraulic braking device. Since a configuration of the hydraulic braking device is a technical matter well known to those having ordinary skill in the art, a detailed description thereof has been omitted.

Referring still to FIG. 1, the friction braking device 50 is illustrated as including a pressure generating unit 51 for generating a controlled braking hydraulic pressure and a wheel brake 52 for applying a friction braking force controlled by the braking hydraulic pressure generated and supplied by the pressure generating unit 51 to the corresponding wheel.

The operation of the friction braking device 50 is controlled by the third controller 23. The third controller 23 is a controller in charge of braking control of the vehicle. The third controller 23 controls the operation of the friction braking device 50 according to the friction braking torque command.

The pressure generating unit 51 generates the braking hydraulic pressure controlled according to the friction braking torque command output from the third controller 23. The braking hydraulic pressure generated by the pressure generating unit 51 is supplied to the wheel brake 52, and thus the braking force controlled by the wheel brake 52 is applied to the corresponding wheel.

As described above, since the operation of the friction braking device 50 is controlled according to the friction braking torque command output by the third controller 23, the controlled friction braking force may be applied to the wheels.

Although in the above description, the control subject has been described separately as the first controller 21, the second controller 22, and the third controller 23, the torque control and friction braking control processes according to embodiments of the present disclosure may be performed by one integrated control element instead of a plurality of controllers.

In the present disclosure, all of the above-described plurality of controllers and the one integrated control element may be collectively referred to as the controller 20. The torque control and friction braking control processes according to the present disclosure, which are described below, may be performed by the controller 20. In the following description, the controller 20 is a controller that is collectively referred to as the first controller 21, the second controller 22, and the third controller 23.

In the driving system of the electric vehicle, backlash may occur when the torque of the driving system is within a backlash band. The backlash band may be defined as a torque region in which backlash may occur in a driving system of a vehicle.

A problem caused by the backlash in the driving system of the vehicle mainly occurs only in a torque region close to zero. Accordingly, the torque region close to zero may be referred to as the backlash band in which the backlash problem may occur.

In the method of controlling the driving system of the vehicle according to embodiments of the present disclosure, the backlash problem in the driving system and the backlash band in which such a backlash problem may occur are considered. The backlash band, which is the torque region in which the backlash may occur in the driving system of the vehicle, may be a torque range bounded by a lower limit threshold having a negative (−) value and an upper limit threshold having a positive (+) value.

In other words, the backlash band may be a torque range including zero and may be generated when an input torque applied from a motor, which is a driving device, to a driving system or applied from a driving wheel to the driving system enters the set backlash band.

The backlash is a tolerance that is present between teeth of two engaged gears. Between the two engaged gears, vibration or noise may be generated as gear teeth hit each other due to the backlash, and in the worst situation, the backlash may cause damage to the gears.

When a torque is continuously applied in one direction, since one of the two engaged gears continuously transmits a force to the other one in the same direction, the teeth of the two engaged gears maintain a state of being aligned and engaged in one direction. In this case, no problem caused by the backlash tolerance occurs.

However, when the direction of the torque is changed, the teeth of the gears are reversely aligned after undergoing the backlash tolerance as the transmission direction of the force is changed. At this time, the problem caused by the backlash does not occur because the engagement of the gears is not released again while the force is continuously re-transmitted in the same direction through the teeth after the teeth are reversely aligned.

However, at the moment when the transmission direction of the force is changed, the problem caused by the backlash occurs when the teeth of the two gears are disengaged and then the engagement is re-performed while passing the engagement tolerance.

Therefore, the core of the method of preventing the occurrence of the backlash problem is to eliminate or minimize the situation in which the gears are disengaged, which can be achieved by eliminating or minimizing the direction change of the torque command for the driving device such as the motor.

In order to eliminate or minimize the direction change of the torque command, the front and rear wheel driving devices, i.e., the front wheel motor and the rear wheel motor, may share the role. To this end, the separation of torque operating regions of the front wheel motor and the rear wheel motor may be considered.

In other words, the torque values of the front wheel torque command and the rear wheel torque command may be restricted so as not to enter the backlash band, which is the torque region in which backlash may occur. To this end, the torque limit value may be set in advance.

In the present disclosure, the torque limit value is defined as an offset torque. In the present disclosure, the offset torque includes a front wheel offset torque for restricting the front wheel torque command and a rear wheel offset torque for restricting the rear wheel torque command.

According to embodiments of the present disclosure, the front wheel offset torque and the rear wheel offset torque are set in the controller 20 in advance. For example, as described below, values of the front wheel offset torque and the rear wheel offset torque for each torque control mode determined according to the vehicle driving state may be set in the controller 20 in advance.

In an embodiment, since the front wheel offset torque and the rear wheel offset torque are used for the purpose of restricting the torque values of the front wheel torque command and the rear wheel torque command to prevent the front wheel torque command and the rear wheel torque command from entering the backlash band, the front wheel offset torque and the rear wheel offset torque may be determined to be torque values out of the backlash band.

In other words, when the front wheel offset torque and the rear wheel offset torque for each torque control mode according to the vehicle driving state have the positive (+) values, each of the front wheel offset torque and the rear wheel offset torque may be set to a value larger than the upper limit threshold (positive (+) value) of the backlash band set to the torque region in which backlash may occur in the front wheel side driving system and the rear wheel side driving system.

Conversely, when the front wheel offset torque and the rear wheel offset torque for each torque control mode according to the vehicle driving state have the negative (−) values, each of the front wheel offset torque and the rear wheel offset torque may be set to a value smaller than the lower limit threshold (negative (−) value) of the backlash band set to the torque region in which backlash may occur in the front wheel side driving system and the rear wheel side driving system.

Hereinafter, the method of controlling the torque of the driving system according to embodiments of the present disclosure is described in more detail.

Prior to a detailed description of the method of controlling the torque of the driving system according to embodiments of the present disclosure, it is noted that when the main signs are first defined in the following description, the entire torque command when the accelerator pedal is currently applied independently (in a state in which the accelerator pedal is ON and the brake pedal is OFF) is referred to as “T_{acl},” and a front wheel torque command distributed from the entire torque command when only the accelerator pedal is currently applied is referred to as “T_{f}.”

In addition, the rear wheel torque command distributed from the entire torque command when only the accelerator pedal is currently applied is referred to as “Tᵣ.” In this case, since the front wheel torque command and the rear wheel torque command are distributed from the entire torque command, the relationship between the entire torque command, which is the total torque command, the front wheel torque command and the rear wheel torque command becomes “T_{acl}=T_{f}+Tᵣ.”

In addition, the entire torque command when both the accelerator pedal and the brake pedal are currently released (in a state in which the accelerator pedal is OFF and the brake pedal is OFF) is referred to as “T_{cst}.” In embodiments of the present disclosure, allowing the simultaneous application of the accelerator pedal and the brake pedal and developing the operation strategy thereof may be restricted to be operated only when a value of T_{cst} has the negative (−) value, i.e., when a current vehicle speed is higher than that of a creep section. The entire torque command T_{cst} when the vehicle speed is higher than that of the creep section and both of the two pedals are released becomes a negative (−) torque value as a regenerative braking torque value.

In addition, the entire torque command when only the brake pedal is currently applied is defined as “T_{cst+brk}.” In this case, the entire torque command T_{cst+brk} becomes the negative (−) torque value. It is assumed that T_{cst} has the negative (−) value, and since this is a case in which the brake pedal is additionally applied thereto, T_{cst+brk} inevitably has the negative (−) value as well.

In addition, an amount of the torque command (amount of braking torque) to be added when the accelerator pedal and the brake pedal are simultaneously applied is defined as “T_{brk},” and the torque command T_{brk} to be added has the relationship of “T_{brk}=T_{cst+brk}−T_{cst}.”

When the driver applies the brake pedal, a negative (−) torque value corresponding to the amount of the applied brake pedal should be reflected in the entire torque command. In this case, the amount of the torque command to be reflected is the amount of the braking torque T_{brk}. Since the amount of the torque command is a value in which the amount of the applied brake pedal is reflected, the torque command is a negative (−) directional torque, i.e., a torque having the negative (−) value, which is a deceleration direction.

As described above, when the entire torque command is newly determined by reflecting the deceleration directional torque according to the application of the brake pedal in the entire torque command, since T_{brk}, which is the amount of the torque command corresponding to the amount of the applied brake pedal, is a torque having the negative (−) value, T_{brk} having the negative (−) value is added to the entire torque command.

Since T_{brk} has the negative (−) value, adding T_{brk} having the negative (−) value to the entire torque command means subtracting an absolute value of T_{brk} from the entire torque command. Here, even when an object to which T_{brk} having the negative (−) value is added and an object to which the absolute value of T_{brk} is added are not the entire torque command, adding T_{brk} having the negative (−) value to the object represents the same meaning as subtracting the absolute value of T_{brk} from the same object.

In addition, in embodiments of the present disclosure, a plurality of torque control modes classified according to the vehicle driving state are set in the controller 20. The plurality of torque control modes set in the controller 20 include an acceleration-directivity co-directional distribution mode, a regeneration-directivity co-directional distribution mode, an acceleration-directivity reverse distribution mode, and a regeneration-directivity reverse distribution mode.

In addition, the front wheel offset torque and the rear wheel offset torque are respectively defined as “T_{ofs,f}” and “T_{ofs,r}.” According to embodiments of the present disclosure, values of the front wheel offset torque T_{ofs,f} and the rear wheel offset torque T_{ofs,r} may be the negative (−) values or the positive (+) values.

The front wheel offset torque and the rear wheel offset torque are set in the controller 20 in advance to values according to the torque control modes. When the controller 20 determines the torque control mode according to the current vehicle driving state, the front wheel torque offset and the rear wheel torque offset are determined to be values corresponding to the determined current torque control mode. The front wheel torque offset and the rear wheel torque offset are then used to determine the front wheel torque command and the rear wheel torque command while the torque control mode is performed.

Depending on the vehicle driving state and the front and rear wheel torque distribution states, signs of the values of the front wheel offset torque and the rear wheel offset torque in each torque control mode may be determined to be the same sign or determined to be different signs among negative (−) or positive (+).

In embodiments of the present disclosure, the signs of the values of the front wheel offset torque T_{ofs,f} and the rear wheel offset torque T_{ofs,r} may be determined as follows among the negative (−) and positive (+) values depending on the torque control mode classified based on the vehicle driving state and the front and rear wheel torque distribution states.

In the acceleration-directivity co-directional distribution, T_{ofs,f} is the positive (+) value, and T_{ofs,r} is the positive (+) value.

In the regeneration-directivity co-directional distribution, T_{ofs,f} is the negative (−) value, and T_{ofs,r} is the negative (−) value.

In the acceleration-directivity reverse distribution, T_{ofs,f} is the negative (−) value, and T_{ofs,r} is the positive (+) value.

In the regeneration-directivity reverse distribution, T_{ofs,f} is the negative (−) value, and T_{ofs,r} is the positive (+) value.

In the above example, the torque control mode is classified into the acceleration-directivity and the regeneration-directivity depending on the vehicle driving state. A current vehicle driving state may be determined to be any one of the acceleration-directivity and the regeneration-directivity according to the direction of the required torque (torque of the entire torque command) determined depending on the vehicle driving state.

In this case, when the entire torque command, which is the required torque command determined depending on the vehicle driving state, has the positive (+) torque value, which is the driving direction (acceleration direction), the current vehicle driving state may be determined to be the acceleration-directivity. On the other hand, when the entire torque command has the negative (−) torque value, which is the regenerative direction (deceleration direction), the current vehicle driving state may be determined to be the regeneration-directivity.

In addition, in the front and rear wheel torque distribution states, the co-directional distribution is defined as a case in which both the front wheel torque command and the rear wheel torque command are torques in the same direction, i.e., a case in which both the front wheel torque command and the rear wheel torque command have torques having the positive (+) value, which is the driving direction (acceleration direction), or torques having the negative (−) value, which is the regeneration direction (deceleration direction) (the distributed front wheel torque and rear wheel torque are torques in the same direction).

The reverse distribution is defined as a case in which the front wheel torque command and the rear wheel torque command are torques in opposite directions, i.e., a case in which when any one of the front wheel torque command and the rear wheel torque command is the torque having the positive (+) value, which is the driving direction, the other one is the torque having the negative (−) value, which is the regeneration direction (the distributed front wheel torque and rear wheel torque are torques in opposite directions).

As described above, when the controller 20 determines one torque control mode corresponding to the current vehicle driving state among the plurality of (four) set torque control modes, signs of the front wheel offset torque and the rear wheel offset torque may be determined depending on the determined torque control mode.

In addition, absolute values of the front wheel offset torque and the rear wheel offset torque may be set in the controller in advance, and final values of the front wheel offset torque and the rear wheel offset torque may be determined from the set absolute values by reflecting the signs according to the torque control modes.

As described above, the front wheel offset torque value for each torque control mode may have different negative (−) and positive (+) signs according to the torque control modes but have the same absolute value. Likewise, the rear wheel offset torque value for each torque control mode may also have different negative (−) and positive (+) signs according to the torque control modes but have the same absolute value. The value of the front wheel offset torque or the rear wheel offset torque may have a different absolute value for each torque control mode.

In addition, the value of the front wheel offset torque or the rear wheel offset torque in the controller may be a variable value that varies depending on the state of the driving system of the vehicle. In this case, the value of the front wheel offset torque or the rear wheel offset torque corresponding to a current state of the driving system may be determined from a map, a table, or the like in the controller.

The state of the driving system may include an input torque applied to the driving system by the motor for driving the vehicle. The input torque may be determined from among the entire torque command, a motor torque estimation value estimated by a motor controller, a motor torque detection value detected by a torque sensor, a value obtained by applying a filter to the entire torque command, a value obtained by applying the filter to the motor torque estimation value, and a value obtained by applying the filter to the motor torque detection value.

Alternatively, the input torque may be a front wheel torque command and a rear wheel torque command determined by a general front and rear wheel torque distribution process of distributing the entire torque command according to a front and rear wheel distribution ratio. In this case, the front wheel offset torque may be changed to a value corresponding to the distributed front wheel torque command, and the rear wheel offset torque may be changed to a value corresponding to the distributed rear wheel torque command.

In the acceleration-directivity reverse mode among the torque control modes, when only the accelerator pedal is applied, the torque value of the front wheel torque command is determined to be the value of the front wheel offset torque set to the negative (−) value, and the torque value of the rear wheel torque command is determined to be a value (value obtained by adding the absolute value of the front wheel offset torque) obtained by subtracting the front wheel offset torque (negative value) from the entire torque command. In other words, a sum of the front wheel torque command and the rear wheel torque command is determined to follow the entire torque command.

In addition, in the regeneration-directivity reverse mode among the torque control modes, when only the accelerator pedal is applied, the torque value of the rear wheel torque command is determined to be the value of the rear wheel offset torque set to the positive (+) value, and the torque value of the front wheel torque command is determined to be a value obtained by subtracting the rear wheel offset torque (positive value) from the entire torque command. The sum of the front wheel torque command and the rear wheel torque command is determined to follow the entire torque command.

While each torque control mode is performed in a state in which only the accelerator pedal is applied, when the brake pedal is additionally applied, the braking torque is not required. Accordingly, the friction braking torque does not need to be generated and the sum of the front wheel torque command and the rear wheel torque command may be determined to follow the entire torque command.

Hereinafter, a method of selecting one of the four torque control modes according to the current vehicle driving state by the controller is described.

The present disclosure provides a method capable of generating a torque command by evading the backlash band in which the backlash of the driving system may occur. According to embodiments, the evasion of the backlash band is to maximally prevent a situation in which the torque command enters the backlash band.

This may be achieved through a method of maintaining the front wheel torque and the front wheel torque command as only the negative (−) torque values and the rear wheel torque and the rear wheel torque command as only the positive (+) torque values. As described above, the backlash issue arise because there are the characteristics that occur when the direction of the torque is changed.

When such a control strategy is applied, the gear is continuously aligned in the negative (−) torque transmission direction so as not to enter the backlash band in the front wheel side driving system, which can be achieved by continuously generating at least a small amount of negative (−) directional torque.

In this case, the small amount of negative (−) directional torque for continuously aligning the gear in the negative (−) torque transmission direction may be defined as a front wheel maximum torque threshold (which is the negative value and the front wheel offset torque). A value (negative value) of the front wheel torque command during backlash band evasion control may be determined in a region that is smaller than or equal to a preset front wheel maximum torque threshold.

Likewise, the gear is continuously aligned in the positive (+) torque transmission direction so as not to enter the backlash band in the rear wheel side driving system, which can be achieved by continuously generating at least a small amount of positive (+) directional torque.

In this case, the small amount of positive (+) directional torque for continuously aligning the gear in the positive (+) torque transmission direction may be defined as a rear wheel minimum torque threshold (which is the positive value and the rear wheel offset torque). A value (positive value) of the rear wheel torque command during the backlash band evasion control may be determined in a region that is larger than or equal to a preset rear wheel minimum torque threshold.

In embodiments of the present disclosure, the front wheel maximum torque threshold may be set to a torque value out of the backlash band, which is the torque region in which the backlash may occur in the front wheel side driving system, in the controller 20. In other words, the front wheel maximum torque threshold may be set to a value smaller than the lower limit threshold (negative value) of the backlash band of the front wheel side driving system.

Likewise, the rear wheel minimum torque threshold may be set to a torque value out of the backlash band, which is the torque region in which the backlash may occur in the rear wheel side driving system, in the controller 20. In this case, the rear wheel minimum torque threshold may be set to a value larger than the upper limit threshold (positive value) of the backlash band of the rear wheel side driving system in the controller 20.

As described above, in order to determine the front wheel torque command to be the negative (−) torque value, which is the torque in the regeneration direction (deceleration direction), and the rear wheel torque command to be the positive (+) torque value, which is the torque in the driving direction (acceleration direction), the front wheel torque command may be determined to be the torque value smaller than or equal to the front wheel maximum torque threshold (negative value). Further, the rear wheel torque command may be determined to be a torque value smaller than or equal to the rear wheel minimum torque threshold (positive value), In this case, the front wheel maximum torque threshold and the rear wheel minimum torque threshold are respectively the front wheel offset torque and the rear wheel offset torque.

In addition, since the front wheel torque command is always determined to be the negative (−) torque value and the rear wheel torque command is always determined to be the positive (+) torque value, a torque direction of the front wheel torque command and a torque direction of the rear wheel torque command are opposite. Accordingly, signs of the two torque commands are opposite among negative (−) and positive (+).

Therefore, the torque distribution is the reverse distribution classified in the present disclosure. When the required torque (entire torque command) has the positive (+) torque value, which is the torque in the driving direction, the torque control mode is the acceleration-directivity reverse distribution mode. Further, when the required torque (entire torque command) has the negative (−) torque value, which is the torque in the regeneration direction, the torque control mode is the regeneration-directivity reverse distribution mode.

In addition, in the acceleration-directivity reverse distribution mode and the regeneration-directivity reverse distribution mode, as described above, the front wheel offset torque T_{ofs,f} is set to the negative (−) torque value in the controller 20 and the rear wheel offset torque T_{ofs,r} is set to the positive (+) torque value in the controller 20.

However, a problem that may occur in this method in that since only the motor of one of the front wheel side and the rear wheel side is used for acceleration (driving) and regenerative braking (deceleration), maximum generation power may be insufficient compared to when the motors of both sides are used for all purposes.

In other words, since the front wheel motor 31 is used for regenerative braking (deceleration) and the rear wheel motor 41 is used for acceleration (driving), the maximum generation power may be insufficient compared to when both the front wheel motor 31 and the rear wheel motor 41 are used for acceleration or regenerative braking. This may make it difficult to achieve maximum acceleration performance or maximum regenerative braking.

However, considering a principle in which, during acceleration, the transmission of the load is concentrated on the rear wheel side and thus the torque of the rear wheel side plays the main role, and conversely, during deceleration, the transmission of the load is concentrated on the front wheel side and thus the regenerative torque of the front wheel side plays the main role, the backlash band evasion strategy provided by the present disclosure does not result in a very large performance degradation.

Nevertheless, since it is certain that when only the motor of one side is used, it is not possible to reach the maximum performance that may be achieved when the motors of both sides are used together, according to embodiments of the present disclosure, the following countermeasures may be performed to overcome this limitation.

First, the reverse distribution mode is set in the controller 20. Accordingly, the reverse distribution mode may be selectively performed by the controller 20. The reverse distribution mode may be referred to as a responsiveness priority mode in which the acceleration/deceleration responsiveness of the vehicle is prioritized. The reverse distribution mode may also be referred to as a backlash band evasion mode in which backlash band evasion control is performed. In the reverse distribution mode, the reverse distribution control in which torque commands in opposite directions are distributed to the front wheels and the rear wheels and torques in opposite directions are applied is performed.

In addition, unlike the reverse distribution mode, the co-directional distribution mode in which maximum power may be generated is set in the controller 20. The co-directional distribution mode may be referred to as a conventional torque control mode applied to general vehicles. In the co-directional distribution mode, torque commands in the same direction are distributed to the front wheels and the rear wheels during acceleration and regeneration of the vehicle and torques in the same direction are applied.

As described above, according to embodiments of the present disclosure, the torque distribution to the front wheels and the rear wheels may be one of the co-directional distribution and the reverse distribution, in which the co-directional distribution allows the torques in the same direction to be distributed and applied to the front wheels and the rear wheels, and the reverse distribution allows the torques in opposite directions to be distributed and applied to the front wheels and the rear wheels.

In other words, upon the co-directional distribution, the front wheel motor and the rear wheel motor are controlled to generate the torques (the positive (+) torques or the negative (−) torques) in the same direction. Accordingly, the front wheel motor and the rear wheel motor generate the torques in the same direction. Thus, the front wheel torque and the rear wheel torque may be added to generate the maximum torque.

However, upon the co-directional distribution, when the required torque passes zero, i.e., when the direction and sign (+ or −) of the required torque are changed, the torque command passes through the backlash band. As a result, a delay in the acceleration/deceleration responsiveness of the vehicle is accompanied due to the control (torque slope restriction) characteristics upon passing through the backlash band.

While the front wheel torque command and the rear wheel torque command pass through the backlash band, backlash control of restricting slopes (change rates) of the front wheel torque command and the rear wheel torque command is performed to prevent a quick increase in the torque command.

For the backlash control, a maximum allowable slope in the backlash band for the front wheel torque command and the rear wheel torque command may be set to a small value that does not cause a backlash impact in the controller 20.

Therefore, while the front wheel torque command and the rear wheel torque command increase or decrease and thus pass through the backlash band, the controller 20 determines the front wheel torque command and the rear wheel torque command to be a value that smoothly varies depending on the maximum allowable slope having the small value.

On the other hand, upon the reverse distribution, the front wheel motor and the rear wheel motor are controlled to generate torques in different directions. For example, the front wheel motor is controlled to generate the negative (−) torque and the rear wheel motor is controlled to generate the positive (+) torque. In this case, the rear wheel motor is in charge of generating the driving torque for vehicle acceleration and the front wheel motor is in charge of generating the regenerative braking torque for vehicle deceleration.

Since the front wheel torque command for controlling the operation of the front wheel motor 31 is always determined and generated to be the negative (−) torque value and the rear wheel torque command for controlling the operation of the rear wheel motor 41 is always determined and generated to be the positive (+) torque value, the torque command does not need to pass through the backlash band during the reverse distribution. Accordingly, it is not necessary to restrict the slope of the torque command in the backlash band, and thus it is possible to increase the acceleration/deceleration responsiveness of the vehicle.

In embodiments of the present disclosure, when the required torque (entire torque command) is the positive (+) direction, since the driving torque for vehicle acceleration should be generated, acceleration-directivity reverse distribution control is performed. In this case, the torque command for the front wheel motor (front wheel torque command) is determined to be the torque command, which is the negative (−) direction.

In addition, an absolute value of the front wheel torque command is determined to be a minimum value at which a state in which the gear teeth are aligned to prevent the occurrence of backlash in the front wheel side driving system may be maintained. Here, the minimum value is the front wheel offset torque (negative value). The front wheel offset torque may be a value that varies depending on the state of the driving system in real time.

In addition, in this case, the torque command for the rear wheel motor (rear wheel torque command) may be determined to be the torque command, which is the positive (+) direction. Further, the rear wheel torque command may be determined to be a value obtained by subtracting the front wheel torque command from the entire torque command (total torque command, which is the pre-distribution torque command) (when the brake pedal is not applied).

Likewise, when the required torque (entire torque command) is in the negative (−) direction, since the regenerative braking torque for vehicle deceleration should be generated, regeneration-directivity reverse distribution control is performed. In this case, the torque command for the rear wheel motor (rear wheel torque command) is determined to be the torque command, which is the positive (+) direction.

In addition, an absolute value of the torque command is determined to be the minimum value at which a state in which the gear teeth are aligned to prevent the occurrence of backlash in the rear wheel side driving system may be maintained. Here, the minimum value is the rear wheel offset torque (positive value). The rear wheel offset torque may be a value that varies depending on the state of the driving system in real time.

In addition, in this case, the torque command for the front wheel motor (front wheel torque command) may be determined to be the torque command, which is the negative (−) direction. Further, the front wheel torque command may be determined to be a value obtained by subtracting the rear wheel torque command from the entire torque command (total torque command, which is the pre-distribution torque command) (when the brake pedal is not applied).

According to the reverse distribution, the maximum driving force or the maximum regenerative braking force may not be generated by the motor, but relatively immediate acceleration/deceleration responsiveness may be expected in all situations.

In embodiments of the present disclosure, the controller 20 selects the reverse distribution mode in a state in which a driver turns off both the accelerator pedal and the brake pedal. Accordingly, after the driver turns on the accelerator pedal, the required torque (command) according to the APS value is smaller than or equal to a preset mode switching threshold.

The required torque may be a total torque adding the front wheel torque and the rear wheel torque as the pre-distribution required torque. In the present specification, the required torque (command) and the entire torque command, which are required for the vehicle to travel, are used in the same sense.

In a state in which both the accelerator pedal and the brake pedal are turned off, the controller 20 selects the regeneration-directivity reverse distribution mode. Further, in an accelerator pedal ON state in which the driver applies the accelerator pedal but a state in which the required torque is smaller than or equal to the mode switching threshold, the controller 20 selects the acceleration-directivity reverse distribution mode.

In addition, when the driver turns on the accelerator pedal in a state in which the regeneration-directivity reverse distribution mode is selected, the regeneration-directivity reverse distribution mode is switched to the acceleration-directivity reverse distribution mode. Conversely, when the driver releases the accelerator pedal to become an accelerator pedal OFF state in a state in which the acceleration-directivity reverse distribution mode is selected, the acceleration-directivity reverse distribution mode is switched to the regeneration-directivity reverse distribution mode.

In addition, until the required torque corresponding to the APS value reaches the mode switching threshold after the regeneration-directivity reverse distribution mode is switched to the acceleration-directivity reverse distribution mode, the acceleration-directivity but the reverse distribution mode (reverse distribution mode in the acceleration direction) is maintained. Thus, zero-crossing of the front wheel torque and the rear wheel torque is not required.

Here, the mode switching threshold may be set to the positive (+) torque value. In addition, the mode switching threshold may be a preset value in a range of a required torque value that may be covered by only the torque of the rear wheel motor.

In addition, in the mode switching threshold, a mode switching threshold for switching the reverse distribution mode to the co-directional distribution mode and conversely, a mode switching threshold for switching the co-directional distribution mode to the reverse distribution mode and re-entering the reverse distribution mode, may be used by being set to different values.

In addition, when the required torque necessary for the vehicle to travel, i.e., the required torque (entire torque command) corresponding to the APS value exceeds the mode switching threshold or the driver applies the brake pedal to become a brake pedal ON state, the controller 20 finishes the reverse distribution mode and switches the reverse distribution mode to the co-directional distribution mode.

In embodiments of the present disclosure, when the required torque necessary for the vehicle to travel, i.e., the required torque corresponding to the APS value in the acceleration-directivity reverse distribution mode, exceeds the mode switching threshold, the controller 20 switches the acceleration-directivity reverse distribution mode to the acceleration-directivity co-directional distribution mode. In addition, when the driver applies the brake pedal to become a brake pedal ON state in the regeneration-directivity reverse distribution mode, the controller 20 switches the regeneration-directivity reverse distribution mode to the regeneration-directivity co-directional distribution mode.

In addition, when the required torque decreases to become smaller than or equal to the mode switching threshold in the acceleration-directivity co-directional distribution mode or the driver releases the brake pedal to become a brake pedal OFF state in the regeneration-directivity co-directional distribution mode, the controller 20 finishes the co-directional distribution mode and returns to the reverse distribution mode again.

Next, a torque command determination and torque control method for each torque control mode, according to embodiments, are described.

In the following description, when any torque or torque command has the negative (−) value, adding the torque or torque command having the negative (−) value to another value means subtracting the absolute value of the torque or the torque command from another value.

In addition, decreasing the torque command having the negative (−) value means that the absolute value of the torque command indicating an amount of regeneration varies in an increasing direction. Conversely, increasing the torque command having the negative (−) value means that the absolute value of the torque command indicating the amount of regeneration varies in a decreasing direction.

In addition, the fact that any torque or torque command having the negative (−) value is larger than or equal to another negative (−) value means that an absolute value of any torque or torque command is smaller than or equal to or smaller than an absolute value of another negative (−) value.

Conversely, the fact that any torque or torque command having the negative (−) value is smaller than or equal to another negative (−) value means that the absolute value of any torque or torque command is larger than or equal to or exceeds the absolute value of another negative (−) value.

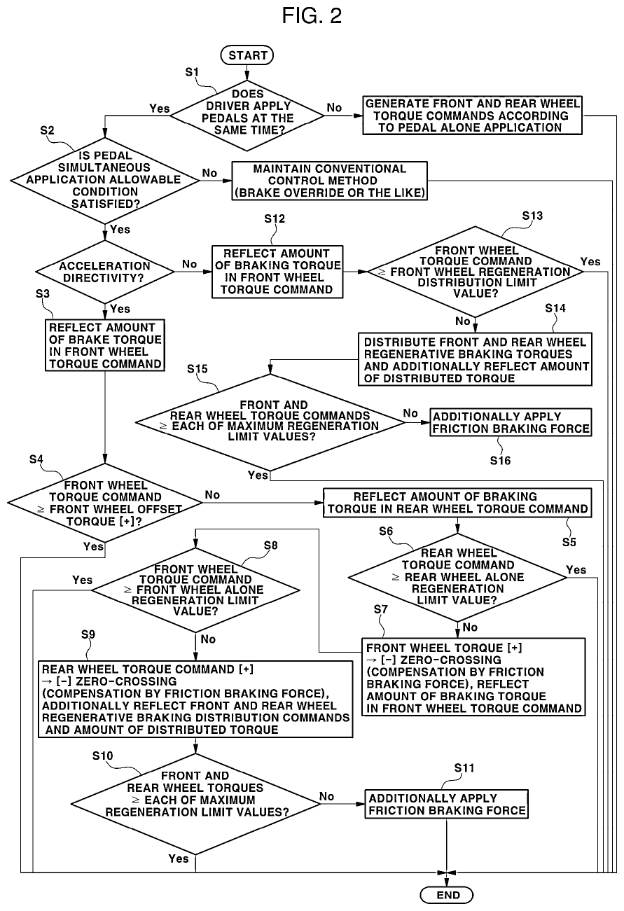

FIG. 2 is a flowchart illustrating a torque control method when pedals are simultaneously applied in acceleration-directivity co-directional distribution and regeneration-directivity co-directional distribution states, according to an embodiment of the present disclosure.

In an operation S1, the controller 20 determines whether the brake pedal is additionally applied while only the accelerator pedal is applied. When it is determined to be a state in which the pedals are simultaneously applied by additionally applying the brake pedal, an amount of a braking torque corresponding to an amount of the applied brake pedal is determined.

In addition, the controller 20 reflects the determined amount of the braking torque in one or two selected according to information indicating the current vehicle driving state and the front and rear wheel torque distribution states among the front wheel torque command and the rear wheel torque command.

Describing in more detail the torque control state when the pedals are simultaneously applied for each torque control mode, first, the acceleration-directivity co-directional distribution mode may be selected when only the accelerator pedal is applied.

A pedal simultaneous application allowable condition in the acceleration-directivity co-directional distribution state is when the entire torque command T_{acl} (i.e., the driver required torque according to the APS value) when only the accelerator pedal is applied just before the brake pedal is applied has the positive (+) value. At this time, both the front wheel torque command T_{f} and the rear wheel torque command Tᵣ distributed from the entire torque command have the positive (+) values.

In embodiments of the present disclosure, the value of the entire torque command is information indicating the vehicle driving state. Further, the front wheel torque command value and the rear wheel torque command value in the state in which only the accelerator pedal is applied are information indicating the front and rear wheel torque distribution states.

In an operation S2, in the state in which the pedals are simultaneously applied by additionally applying the brake pedal in the state in which the accelerator pedal is applied, when the pedal simultaneous application allowable condition in the acceleration-directivity co-directional distribution state is satisfied, the amount of the braking torque is sequentially reflected (the absolute value of the amount of braking torque is subtracted) in the torque command determined according to a set priority.

In other words, upon meeting the pedal simultaneous application allowable condition in the state in which the pedals are simultaneously applied, the amount of the braking torque T_{brk} corresponding to the BPS value (amount of the applied brake pedal) should be reflected in the torque command, and to this end, in embodiments of the present disclosure, the amount of the braking torque T_{brk} having the negative (−) value is reflected (i.e., the absolute value of the amount of the braking torque is subtracted) by being added to a torque command set according to the following priority.

In an operation S3, according to the set priority, the amount of the braking torque T_{brk} is first added to the front wheel torque command T_{f} (T_{f}+T_{bkr}), the absolute value of the amount of the braking torque is subtracted, which is performed until the front wheel torque command after adding the amount of the braking torque T_{brk} is larger than or equal to the value of the front wheel offset torque T_{ofs,f} in the acceleration-directivity co-directional distribution mode determined to be the positive (+) value.

In an operation S4, when the front wheel torque command (T_{f}+T_{brk}) after adding the amount of the braking torque T_{brk} is larger than or equal to the front wheel offset torque T_{ofs,f} in the acceleration-directivity co-directional distribution mode, which is the positive (+) value, the front wheel torque command after adding the amount of the braking torque T_{brk} is determined to be the front wheel torque command in which the amount of the braking torque is reflected.

In this case, the rear wheel torque command Tᵣ is determined to be a value obtained by subtracting the front wheel torque command (value before the amount of the braking torque is reflected) from the entire torque command T_{acl} corresponding to the APS value, and the amount of the braking torque is not reflected in the rear wheel torque command.

In other words, the entire torque command T_{acl} according to the APS value (amount of the applied accelerator pedal) is distributed to each of the front wheel torque command T_{f} and the rear wheel torque command Tᵣ, which are the positive (+) values. When the brake pedal is additionally applied in the state in which the accelerator pedal is applied, the absolute value of the amount of the braking torque T_{brk} according to the BPS value is first subtracted from the front wheel torque command T_{f}, which is the distributed torque with the positive (+) value.

However, in an embodiment, when the front wheel torque command after adding the amount of the braking torque T_{brk} according to the BPS value is decreased to the front wheel offset torque T_{ofs,f} or less in the acceleration-directivity co-directional distribution mode with the positive (+) value, the value of the front wheel offset torque T_{ofs,f}, which is the positive (+) value, is determined to be the front wheel torque command.

As described above, determining the value of the front wheel offset torque T_{ofs,f} to be the front wheel torque command means that all of the amount of the braking torque T_{brk} are not yet reflected because a value obtained by adding some (T_{ofs,f}−T_{f}) of the amount of the braking torque T_{brk} to the front wheel torque command T_{f} distributed from the entire torque command (subtracting the absolute value of some of the amount of the braking torque) is the front wheel offset torque T_{ofs,f}.

Therefore, in operations S4 and S5, after the value of the front wheel offset torque T_{ofs,f} in the acceleration-directivity co-directional distribution mode, which is the positive (+) value, is determined to be the front wheel torque command, the remaining amount of the braking torque {T_{brk}−(T_{ofs,f}−T_{f})=T_{f}−T_{ofs,f}+T_{brk}} among the amount of the braking torque T_{brk}, which will be additionally reflected, is added to the rear wheel torque command Tᵣ, which is the torque having the positive (+) value distributed from the entire torque command T_{acl}.

In other words, the absolute value of the remaining amount of the braking torque is subtracted from the rear wheel torque command Tᵣ, and the torque command {Tᵣ+(T_{f}−T_{ofs,f}+T_{brk})} after adding the remaining amount of the braking torque to the rear wheel torque command Tᵣ is determined to be the rear wheel torque command in which the amount of the braking torque is reflected.

However, in an embodiment, only when the rear wheel torque command after adding the remaining amount of the braking torque (rear wheel torque command after subtracting the absolute value of the remaining amount of the braking torque) is larger than or equal to the value of the rear wheel offset torque T_{ofs,r} in the acceleration-directivity co-directional distribution mode, which is the positive (+) value, the rear wheel torque command after adding the remaining amount of the braking torque is determined to be the rear wheel torque command.

In an operation S7, when the rear wheel torque command {Tᵣ+(T_{f}−T_{ofs,f}+T_{brk})} after adding the remaining amount of the braking torque (T_{f}−T_{ofs,f}+T_{brk}) is decreased to the value of the rear wheel offset torque T_{ofs,r} in the acceleration-directivity co-directional distribution mode or less, after the rear wheel torque command is determined to be the value of the rear wheel offset torque T_{ofs,r}, the remaining amount of the braking torque {(Tᵣ−T_{ofs,r})+(T_{f}−T_{ofs,f})+T_{brk}} not reflected in the rear wheel torque command is additionally added to the front wheel torque command (T_{f}=T_{ofs,f}) in which a portion of the amount of the braking torque is reflected.

However, since the front wheel torque command already has the value of the front wheel offset torque T_{ofs,f} obtained by adding a portion of the amount of the braking torque according to the priority as described above, in this case, when the remaining amount of the braking torque not reflected is additionally reflected in the front wheel torque command, which is the front wheel offset torque T_{ofs,f}, the front wheel torque command becomes a value smaller than or equal to the front wheel offset torque.

Nevertheless, since the amount of the braking torque should be reflected in the distributed torque command, as the amount of the braking torque having the negative (−) value is reflected (the absolute value of the amount of the braking torque is subtracted) in the front wheel torque command after reaching the value of the front wheel offset torque T_{ofs,f}, the front wheel torque command passes through the backlash band and performs zero-crossing while passing through the backlash band.

As described above, the backlash control of restricting the slope of the front wheel torque command while the front wheel torque command passes through the backlash band. In this case, the controller 20 determines the slope of the front wheel torque command to be a value that smoothly varies along a preset maximum allowable slope.

A torque following error caused by a time delay consumed while the front wheel torque command performs the zero-crossing and passes through the backlash band may be corrected using the friction braking torque command (compensated by the friction braking force). The friction braking torque command may be re-released after the front wheel torque command performs the zero-crossing and passes through the backlash band.

In addition, after the front wheel torque command finishes performing the zero-crossing and passing through the backlash band, a value obtained by adding the remaining amount of the braking torque {(Tᵣ−T_{ofs,r})+(T_{f}−T_{ofs,f})+T_{brk}} not reflected in the rear wheel torque command is determined to be a value of a front wheel target torque. The front wheel torque command is decreased until reaching the value of the front wheel target torque [T_{ofs,f}+{(Tᵣ−T_{ofs,r})+(T_{f}−T_{ofs,f})+T_{brk}}].

In an operation S8, the value of the front wheel target torque in which the amount of the braking torque (negative value) is additionally reflected according to the BPS value becomes the front wheel torque command. This is performed until the front wheel torque command is larger than or equal to a preset front wheel alone regeneration limit value (negative value), i.e., until reaching the front wheel alone regeneration limit value.

Here, the front wheel alone regeneration limit value is a limit value of the regenerative torque that may be generated by the front wheel motor in consideration of the limit of a regeneration distribution ratio between the front and rear wheels when only the front wheel motor generates the regenerative torque and is a value set in the controller 20 in advance.

When the front wheel torque command in which the amount of the braking torque (negative value) is additionally reflected reaches the preset front wheel alone regeneration limit value and then becomes smaller than the front wheel alone regeneration limit value, the remaining amount of the braking torque not reflected, which has not been subtracted and exhausted, even thereafter is distributed according to the preset regeneration distribution ratio between the front and rear wheels.

In addition, an amount of a front wheel regenerative braking torque (negative value) and an amount of a rear wheel regenerative braking torque (negative value) distributed according to the regeneration distribution ratio between the front and rear wheels are additionally reflected in each of the current front wheel torque command and rear wheel torque command (absolute values of each of the amounts of the regenerative braking torque are subtracted from the front wheel torque command and the rear wheel torque command).

In order to secure vehicle attitude stability, since an appropriate regenerative torque ratio between the front and rear wheels should be maintained, it is not possible to decrease only the front wheel torque command in a state in which the rear wheel torque command is maintained as the rear wheel offset torque T_{ofs,r}. Therefore, when the front wheel torque command becomes smaller than the front wheel alone regeneration limit value, a portion of the amount of the braking torque is reflected in the rear wheel torque command.

In this case, in an operation S9, the rear wheel torque command, which is the value of the rear wheel offset torque T_{ofs,r}, is decreased to the negative (−) torque range by passing through the backlash band while additionally performing zero-crossing. Further, the backlash control of restricting the slope of the rear wheel torque command is performed while the rear wheel torque command passes through the backlash band.

In other words, the controller 20 determines the slope of the rear wheel torque command to be a value that smoothly varies along the preset maximum allowable slope while the rear wheel torque command passes through the backlash band. In this case, the torque following error for the entire torque command caused by the time delay consumed while the rear wheel torque command performs the zero-crossing and passes through the backlash band may be corrected using an additional friction braking torque command (compensated by additionally applying the friction braking force). Further, the friction braking torque command may be re-released after the rear wheel torque command performs the zero-crossing and passes through the backlash band.

Then, since the front wheel torque command and the rear wheel torque command may not respectively exceed preset front wheel maximum regeneration limit value and rear wheel maximum regeneration limit value, the friction braking device 50 may additionally generate the friction braking torque in order to compensate the insufficient amount of the braking torque when the front wheel torque command and the rear wheel torque command, which vary depending on the BPS value, respectively reach the front wheel maximum regeneration limit value and the rear wheel maximum regeneration limit value.

Here, the front wheel maximum regeneration limit value and the rear wheel maximum regeneration limit value are maximum values of the amount of regeneration at which regeneration may be performed by the front wheel motor and are values set in the controller 20 in advance.

Then, when only the brake pedal is released in the state in which the application of the accelerator pedal is maintained, the reflection of the amount of the braking torque (i.e., adding the amount of the braking torque having the negative (−) value or subtracting the absolute value of the amount of the braking torque) is released in a reverse order of the priority.

In addition, thereafter, when the following error for the entire torque command is generated due to restricting the slope of the torque command passing through the backlash band when any one of the front wheel torque command and the rear wheel torque command performs zero-crossing from the regeneration direction to the driving direction and passes through the backlash band, the compensation may be performed as much as the following error using the other one to follow the entire torque command.

In addition, after performing the zero-crossing and passing through the backlash band, the rear wheel torque command is changed to a rear wheel target torque having the negative (−) value. Further, when the rear wheel target torque (negative value) has a negative (−) torque value smaller than a preset rear wheel alone regeneration limit value (negative value), the rear wheel torque command is determined to be the rear wheel alone regeneration limit value.

In addition, the remaining amount of the braking torque not reflected, which has not yet been subtracted and consumed, i.e., the insufficient negative (−) torque obtained by subtracting the rear wheel alone regeneration limit value (negative value) from the rear wheel target torque (negative value), is compensated with the friction braking torque of the friction braking device by additionally generating the friction braking torque command.

Since the front wheel torque command and the rear wheel torque command are respectively determined to be the front wheel alone regeneration limit value and the rear wheel alone regeneration limit value, it is no longer possible to generate the regenerative braking torque by the motor. Thus, the insufficient braking torque is compensated with the friction braking torque.

In addition, when the brake pedal is re-released after the brake pedal is simultaneously applied in the state in which the accelerator pedal is applied, the reflection of the braking torque (i.e., adding the amount of the braking torque having the negative (−) value or subtracting the absolute value of the amount of the braking torque) is released in the reverse order of the priority.

In addition, thereafter, when the following error for the entire torque command is generated due to restricting the slope of the torque command passing through the backlash band when any one of the front wheel torque command and the rear wheel torque command performs zero-crossing from the regeneration direction to the driving direction and passes through the backlash band, the compensation is performed as much as the following error additionally using the other one or the friction braking torque command to follow the entire torque command.

As a result, the final front wheel torque command and rear wheel torque command may be determined through a process of sequentially reflecting the amount of the braking torque according to the set priority. The front wheel motor and the rear wheel motor may be controlled according to the determined final front wheel torque command and rear wheel torque command.

The regeneration-directivity co-directional distribution mode may also be selected when only the accelerator pedal is applied. A pedal simultaneous application allowable condition in the regeneration-directivity co-directional distribution state is when the entire torque command T_{acl} when only the accelerator pedal is applied just before the brake pedal is applied has the negative (−) value and both the front wheel torque command T_{f} and at this time, the rear wheel torque command Tᵣ distributed from the entire torque command have the negative (−) values.

Here, the reason why the entire torque command may become the negative (−) value even when only the accelerator pedal is applied is that vehicles currently being mass-produced are equipped with a function of allowing a driver to adjust a strength of the regenerative braking.

In electric vehicles which may allow a driver to adjust the strength of the regenerative braking to a desired level as the driver selects and sets a regenerative braking level by classifying the strength of the regeneration braking into a plurality of regenerative braking levels, the motor is supposed to perform the regenerative braking according to the regenerative braking levels set by the driver in a state in which both the accelerator pedal and the brake pedal are released in a speed higher than or equal to that of a creep condition.

In addition, until the driver applies the accelerator pedal as much as a certain amount or more, the amount of the regenerative braking is adjusted instead of adjusting an acceleration torque according to the APS value (amount of the applied accelerator pedal).

Furthermore, in electric vehicles equipped with a driving mode function of one-pedal driving, acceleration, deceleration, and stopping may be performed by using only the accelerator pedal. In other words, the one-pedal driving is a function of inducing the vehicle to decelerate by performing the regenerative braking when all pedals are released and allowing this state to be maintained up to a stopped state. Therefore, in vehicles equipped with these functions, when only the accelerator pedal is applied, the entire torque command has the negative (−) value in many cases.

In embodiments of the present disclosure, in the state in which the pedals are simultaneously applied by additionally applying the brake pedal in the state in which the accelerator pedal is applied, when the pedal simultaneous application allowable condition in the regeneration-directivity co-directional distribution state is satisfied, the amount of the braking torque is sequentially reflected (the absolute value of the amount of braking torque is subtracted) in the torque command determined according to the set priority.

In other words, in operations S2 and S12, when the pedal simultaneous application allowable condition is satisfied in the state in which the pedals are simultaneously applied, the amount of the braking torque T_{brk} having the negative (−) value is added (i.e., the absolute value of the amount of the braking torque is subtracted) according to the following priority.

In a state in which the accelerator pedal and the brake pedal are simultaneously applied in the regeneration-directivity co-directional distribution state, the controller 20 determines the amount of the braking torque T_{brk} according to the BPS value and then first adds the amount of the braking torque T_{brk} having the negative (−) value and the front wheel torque command T_{f} and reflects the added value (the absolute value of the amount of the braking torque is subtracted from the front wheel torque command).

In this case, the rear wheel torque command Tᵣ is determined to be a value obtained by subtracting the front wheel torque command (value before the amount of the braking torque is reflected) from the entire torque command T_{acl} corresponding to the APS value, and the amount of the braking torque is not reflected in the rear wheel torque command.

This is performed until it is determined, in an operation S13, that the front wheel torque command after adding the amount of the braking torque T_{brk} (subtracting the absolute value of the amount of the braking torque) is larger than or equal to the front wheel alone regeneration limit value set as the negative (−) value in advance. Accordingly, this is performed until the absolute value of the front wheel torque command having the negative (−) value is smaller than or equal to the absolute value of the front wheel alone regeneration limit value, which is the negative (−) value.

Here, the front wheel alone regeneration limit value is a limit value of the regenerative torque that may be generated by the front wheel motor in consideration of the limit of a regeneration distribution ratio between the front and rear wheels when only the front wheel motor generates the regenerative torque and is a value set in the controller 20 in advance.

However, in an operation S14, when the front wheel torque command after adding the amount of the braking torque T_{brk} according to the BPS value becomes smaller than the front wheel alone regeneration limit value, which is the negative (−) value, i.e., when the absolute value of the front wheel torque command becomes larger than the absolute value of the front wheel alone regeneration limit value, the remaining amount of the braking torque of the amount of the braking torque T_{brk}, which will be additionally reflected, is distributed according to the preset regeneration distribution ratio between the front and rear wheels.

In addition, in the operation S14, the amount of the front wheel regenerative braking torque (negative value) and the amount of the rear wheel regenerative braking torque (negative value) distributed according to the regeneration distribution ratio between the front and rear wheels are additionally reflected in each of the current front wheel torque command and rear wheel torque command (the absolute values of each of the amounts of the regenerative braking torque are subtracted from the front wheel torque command and the rear wheel torque command).

In order to secure vehicle attitude stability, an appropriate regenerative torque ratio between the front and rear wheels should be maintained. Thus, it is not possible to decrease only the front wheel torque command. Therefore, when the front wheel torque command becomes smaller than the front wheel alone regeneration limit value, a portion of the amount of the braking torque is reflected in the rear wheel torque command.

In this case, the amount of the front wheel regenerative braking torque and the amount of the rear wheel regenerative braking torque having the negative (−) value are respectively added to the front wheel torque command and the rear wheel torque command. Since the absolute value of the front wheel regenerative braking torque is subtracted from the front wheel torque command and the amount of the rear wheel regenerative braking torque is subtracted from the rear wheel torque command, the magnitudes of the front wheel torque command and the rear wheel torque command vary in a direction in which the amount of regeneration increases.

In addition, since the front wheel torque command and the rear wheel torque command may not respectively exceed the preset front wheel maximum regeneration limit value and rear wheel maximum regeneration limit value, in operations S15 and S16, the friction braking device 50 may additionally generate the friction braking torque in order to compensate the insufficient amount of the braking torque when the front wheel torque command and the rear wheel torque command, which vary depending on the BPS value, respectively reach the front wheel maximum regeneration limit value and the rear wheel maximum regeneration limit value.

Here, the front wheel maximum regeneration limit value and the rear wheel maximum regeneration limit value are maximum values of the amount of regeneration at which regeneration may be performed by the front wheel motor and are values set in the controller 20 in advance.

Then, when only the brake pedal is released in the state in which the application of the accelerator pedal is maintained, the reflection of the amount of the braking torque (i.e., adding the amount of the braking torque having the negative (−) value or subtracting the absolute value of the amount of the braking torque) is released in a reverse order of the priority.

In addition, thereafter, when the following error for the entire torque command is generated due to restricting the slope of the torque command passing through the backlash band when any one of the front wheel torque command and the rear wheel torque command performs zero-crossing from the regeneration direction to the driving direction and passes through the backlash band, the compensation may be performed as much as the following error using the other one to follow the entire torque command.

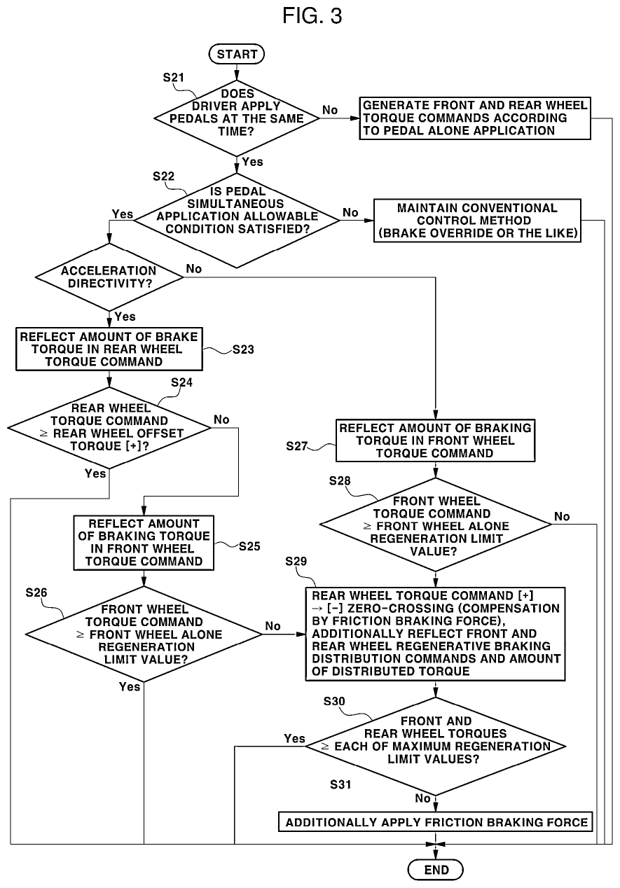

Next, FIG. 3 is a flowchart illustrating a torque control method when pedals are simultaneously applied in acceleration-directivity reverse distribution and regeneration-directivity reverse distribution states, according to an embodiment of the present disclosure.

The acceleration-directivity reverse distribution mode may be selected when only the accelerator pedal is applied, and the pedal simultaneous application allowable condition in the acceleration-directivity reverse distribution state is when the entire torque command T_{acl} when only the accelerator pedal is input just before the brake pedal is applied has the positive (+) value. At this time, the front wheel torque command T_{f} distributed from the entire torque command has the negative (−) value, and the rear wheel torque command Tᵣ distributed therefrom has the positive (+) value.

In the acceleration-directivity reverse distribution state, a sum of the front wheel torque command T_{f} and the rear wheel torque command Tᵣ should follow the entire torque command T_{acl} (T_{acl}=T_{f}+Tᵣ), in which the front wheel torque command T_{f}(T_{f}=T_{ofs,f}) is determined to be the value of the front wheel offset torque T_{ofs,f} having the negative (−) value and the rear wheel torque command Tᵣ is determined to be a value (Tᵣ=T_{acl}−T_{ofs,f}) obtained by subtracting the front wheel offset torque T_{ofs,f} having the negative (−) value from the entire torque command T_{acl} having the positive (+) value.

Referring to FIG. 3, in the state in which the pedals are simultaneously applied by additionally applying the brake pedal in the state in which the accelerator pedal is applied, as determined in an operation S21 and when the pedal simultaneous application allowable condition in the acceleration-directivity reverse distribution state is satisfied, as determined in an operation S22, the amount of the braking torque is sequentially reflected (the absolute value of the amount of braking torque is subtracted) in the torque command determined according to the set priority.

In other words, when the pedal simultaneous application allowable condition is satisfied in the state in which the pedals are simultaneously applied, in order to reflect the amount of the braking torque T_{brk} corresponding to the BPS value (amount of the applied brake pedal) in the torque command, the amount of the braking torque T_{brk} having the negative (−) value is reflected (i.e., the absolute value of the amount of the braking torque is subtracted) by being added to the torque command determined according to the following priority.

In an operation S23, according to the set priority, the amount of the braking torque T_{brk} is first added to the rear wheel torque command Tᵣ (Tᵣ+T_{bkr}), the absolute value of the amount of the braking torque is subtracted). Operation 23 is performed until the rear wheel torque command after adding the amount of the braking torque T_{brk} is larger than or equal to the value of the rear wheel offset torque T_{ofs,r} in the acceleration-directivity reverse distribution mode, which is set to the positive (+) value.

In this case, the front wheel torque command T_{f} is determined to be a value obtained by subtracting the rear wheel torque command (value before the amount of the braking torque is reflected) from the entire torque command T_{acl} corresponding to the APS value.

When it is determined, in an operation S24, that the rear wheel torque command (Tᵣ+T_{ofs,r}) after adding the amount of the braking torque T_{brk} is larger than or equal to the rear wheel offset torque T_{ofs,r} in the acceleration-directivity reverse distribution mode set to the positive (+) value, the rear wheel torque command after adding the amount of the braking torque T_{brk} is determined to be the rear wheel torque command in which the amount of the braking torque is reflected, and in this case, the amount of the braking torque is not reflected in the front wheel torque command T_{f}.

In other words, the entire torque command T_{acl} according to the APS value (amount of the applied accelerator pedal) is distributed to each of the front wheel torque command T_{f} having the negative (−) value and the rear wheel torque command Tᵣ having the positive (+) value. Further, when the brake pedal is additionally applied in the state in which the accelerator pedal is applied, the absolute value of the amount of the braking torque T_{brk} according to the BPS value is first subtracted from the rear wheel torque command Tᵣ, which is the distributed torque having the positive (+) value.

However, in an embodiment, when the rear wheel torque command after adding the amount of the braking torque T_{brk} according to the BPS value is decreased to the rear wheel offset torque T_{ofs,r} or less in the acceleration-directivity reverse distribution mode, which has the positive (+) value, the value of the rear wheel offset torque T_{ofs,r} having the positive (+) value in the acceleration-directivity reverse distribution mode is determined to be the rear wheel torque command.

As described above, determining the value of the rear wheel offset torque T_{ofs,r} to be the rear wheel torque command means that all of the amount of the braking torque T_{brk} are not yet reflected because a value obtained by adding some (T_{ofs,r}−Tᵣ) of the amount of the braking torque T_{brk} and the rear wheel torque command Tᵣ distributed from the entire torque command (subtracting the absolute value of some of the amount of the braking torque) is the rear wheel offset torque T_{ofs,r}.

Therefore, after, in an operation S24, the value of the rear wheel offset torque T_{ofs,r} having the positive (+) value in the acceleration-directivity reverse distribution mode is determined to be the rear wheel torque command, the remaining amount of the braking torque {T_{brk}−(T_{ofs,r}−Tᵣ)=Tᵣ−T_{ofs,r}+T_{brk}} of the amount of the braking torque T_{brk}, which will be additionally reflected, is added to the front wheel torque command T_{f}, which is the torque having the negative (−) value in an operation S25.

In other words, the absolute value of the remaining amount of the braking torque is subtracted from the front wheel torque command T_{f}, and the torque command {T_{f}+(Tᵣ−T_{ofs,f}+T_{brk})} after adding the remaining amount of the braking torque and the front wheel torque command T_{f} is determined to be the front wheel torque command in which the amount of the braking torque is reflected.

However, in the acceleration-directivity reverse distribution state when only the accelerator pedal is applied, this is a state in which the front wheel torque command T_{f} distributed from the entire torque command T_{acl} has been already determined to be the value of the front wheel offset torque T_{ofs,f} having the negative (−) value in the acceleration-directivity reverse distribution mode.

Therefore, when the braking pedal is additionally applied in the acceleration-directivity reverse distribution mode, since the amount of the braking torque T_{brk} according to the BPS value, i.e., the remaining amount of the braking torque {T_{brk}−(T_{ofs,r}−Tᵣ)=Tᵣ−T_{ofs,r}+T_{brk}} of the amount of the braking torque T_{brk}, which has not been reflected in the rear wheel torque command, has the negative (−) value, when the front wheel torque command is determined by adding the remaining amount of the braking torque having the negative (−) value and the front wheel offset torque T_{ofs,f} having the negative (−) value (subtracting the absolute value of the remaining amount of the braking torque from the front wheel offset torque), the amount of the braking torque may be reflected in the front wheel torque command up to the negative (−) torque, which is a target, without performing the zero-crossing and passing through the backlash band.

However, in an embodiment, only when the front wheel torque command after adding the remaining amount of the braking torque (front wheel torque command after subtracting the absolute value of the remaining amount of the braking torque) is larger than or equal to the front wheel alone regeneration limit value or more set to the negative (−) value in advance, the front wheel torque command after adding the remaining amount of the braking torque may be determined to be the front wheel torque command.

Here, the front wheel alone regeneration limit value is a limit value of the regenerative torque that may be generated by the front wheel motor in consideration of the limit of a regeneration distribution ratio between the front and rear wheels when only the front wheel motor generates the regenerative torque and is a value set in the controller 20 in advance.

When the front wheel torque command after adding the remaining amount of the braking torque is the negative (−) torque value smaller than the front wheel alone regeneration limit value, which is the negative (−) value (when the absolute value of the front wheel torque command is larger than the absolute value of the front wheel alone regeneration limit value), the front wheel alone regeneration limit value is determined to be the front wheel torque command.

In addition, in an operation S29, after the amount of the braking torque not reflected, which has not yet been subtracted and exhausted, is distributed according to the preset regeneration distribution ratio between the front and rear wheels, the amount of the distributed front wheel regenerative braking torque (negative value) and rear wheel regenerative braking torque (negative value) are additionally reflected in the current front wheel torque command and rear wheel torque command, respectively (the absolute values of the amounts of the front wheel regenerative braking torque and the rear wheel regenerative braking torque are respectively subtracted from the front wheel torque command and the rear wheel torque command).

In order to secure vehicle attitude stability, since an appropriate regenerative torque ratio between the front and rear wheels should be maintained, it is not possible to decrease only the front wheel torque command in a state in which the rear wheel torque command is maintained as the rear wheel offset torque T_{ofs,r}. Therefore, when the front wheel torque command after adding the remaining amount of the braking torque (negative value) becomes smaller than the front wheel alone regeneration limit value, a portion of the amount of the braking torque is reflected in the rear wheel torque command.

In this case, since the rear wheel torque command Tᵣ is in a state of being maintained as the rear wheel offset torque T_{ofs,r} having the positive (+) value and the amount of the distributed rear wheel regenerative braking torque has the negative (−) torque value, when the rear wheel torque command Tᵣ, which is the rear wheel offset torque T_{ofs,r}, is added to the amount of the rear wheel regenerative braking torque having the negative (−) value (i.e., when the absolute value of the amount of the rear wheel regenerative braking torque is subtracted), the rear wheel torque command enters the backlash band.

In this case, the rear wheel torque command should be decreased to the negative (−) torque region by passing through the backlash band while performing the zero-crossing. In an operation S29, while the rear wheel torque command passes through the backlash band, the backlash control of restricting the slope of the rear wheel torque command is performed.

In other words, the controller 20 determines the slope of the rear wheel torque command to be a value that smoothly varies along the preset maximum allowable slope while the rear wheel torque command passes through the backlash band. In this case, a torque following error caused by restricting the slope of the rear wheel torque command is compensated by generating an additional front wheel torque command in the regeneration direction or friction braking torque command as much as the following error.

In addition, upon finishing performing the zero-crossing and passing through backlash band, the additional generation of the front wheel torque command or the additional generation of the friction braking torque command for compensation may be stopped and released again. In addition, upon finishing performing the zero-crossing and passing through the backlash band, as described above, the amount of the front wheel regenerative braking torque (negative value) and the amount of the rear wheel regenerative braking torque (negative value) to which the amount of the braking torque to be additionally reflected is distributed according to the regeneration distribution ratio between the front and rear wheels are reflected in the front wheel torque command and the rear wheel torque command.

In this case, the amount of the front wheel regenerative braking torque and the amount of the rear wheel regenerative braking torque having the negative (−) value are respectively added to the front wheel torque command and the rear wheel torque command. Since the absolute value of the front wheel regenerative braking torque is subtracted from the front wheel torque command and the amount of the rear wheel regenerative braking torque is subtracted from the rear wheel torque command, the magnitudes of the front wheel torque command and the rear wheel torque command vary in a direction in which the amount of regeneration increases.

In addition, since the front wheel torque command and the rear wheel torque command may not respectively exceed the preset front wheel maximum regeneration limit value and rear wheel maximum regeneration limit value, in operations S30 and S31, the friction braking device 50 may additionally generate the friction braking torque in order to compensate the insufficient amount of the braking torque when the front wheel torque command and the rear wheel torque command, which vary depending on the BPS value, respectively reach the front wheel maximum regeneration limit value and the rear wheel maximum regeneration limit value. Here, the front wheel maximum regeneration limit value and the rear wheel maximum regeneration limit value are maximum values of the amount of regeneration at which regeneration may be performed by the front wheel motor and are values set in the controller 20 in advance.

Then, when only the brake pedal is released in the state in which the application of the accelerator pedal is maintained, the reflection of the amount of the braking torque (i.e., adding the amount of the braking torque having the negative (−) value or subtracting the absolute value of the amount of the braking torque) is released in a reverse order of the priority.

In addition, thereafter, when the following error for the entire torque command is generated due to restricting the slope of the torque command passing through the backlash band when any one of the front wheel torque command and the rear wheel torque command performs zero-crossing from the regeneration direction to the driving direction and passes through the backlash band, the compensation may be performed as much as the following error using the other one to follow the entire torque command.

In the above-described acceleration-directivity co-directional distribution and regeneration-directivity co-directional distribution states, the amount of the braking torque according to the application of the brake pedal is reflected by being first added to the front wheel torque command (the absolute value of the amount of the braking torque is subtracted). However, when the brake pedal is additionally applied in the acceleration-directivity reverse distribution state, the amount of the braking torque is reflected by being first added to the rear wheel torque command (subtracting the absolute value of the amount of the braking torque). There are the following two principles for reducing the understeer of the vehicle.
Principle 1) Increasing the vertical load acting on the front wheel side due to the transmission of the load forward from the vehicle.
Principle 2) Decreasing the amount of the driving force applied to the front wheels in consideration of the characteristics of the friction circle of the tire.

Since, when both the accelerator pedal and the brake pedal are simultaneously applied during the acceleration-directivity co-directional distribution, this is a state in which the torque having the positive (+) value is applied to the front wheels, when the amount of the braking torque is reflected by being first added to the front wheel torque command (the absolute value of the amount of the braking torque is first subtracted), it is possible to meet Principles 1 and 2 at the same time.

However, since the front wheel torque command is in a state of already having the front wheel offset torque value close to zero when the accelerator pedal and the brake pedal are simultaneously applied during the acceleration-directivity reverse distribution, when the amount of the braking torque is reflected by being first added to the front wheel torque command (the absolute value of the amount of the braking torque is first subtracted), the magnitude of the longitudinal driving force of the front wheel maintains the value close to zero. Therefore, it is not possible to apply the principles in which understeer is mitigated by maximizing the lateral force of the front wheel.

However, since the rear wheel torque is in a state of having the positive (+) value, when the amount of the braking torque is reflected by being first added to the rear wheel torque command (the absolute value of the amount of the braking torque is first subtracted), the forward transmission of the load occurs due to a decrease in the vehicle acceleration, and thus it is possible to mitigate the understeer by increasing a vertical drag force of the front wheel.

Therefore, when the pedals are simultaneously applied in the acceleration-directivity reverse distribution state, it is desirable to first reflect the amount of the braking torque in the rear wheel torque command (first subtract the absolute value of the amount of the braking torque).

The regeneration-directivity reverse distribution mode may also be selected when only the accelerator pedal is applied. In addition, the pedal simultaneous application allowable condition in the regeneration-directivity reverse distribution state is when the entire torque command T_{acl} when only the accelerator pedal is applied just before the brake pedal is applied has the negative (−) value. At this time, the front wheel torque command T_{f} distributed from the entire torque command T_{acl} has the negative (−) value and the rear wheel torque command Tᵣ distributed therefrom has the positive (+) value.

In the regeneration-directivity reverse distribution state, the sum of the front wheel torque command T_{f} and the rear wheel torque command Tᵣ should follow the entire torque command T_{acl} (T_{acl}=T_{f}+Tᵣ), in which the rear wheel torque command Tᵣ (Tᵣ=T_{ofs,f}) is determined to be the value of the rear wheel offset torque T_{ofs,r} having the positive (+) value and the front wheel torque command T_{f} is determined to be a value (T_{f}=Tad−T_{ofs,r}) obtained by subtracting the rear wheel offset torque T_{ofs,r} having the positive (+) value from the entire torque command T_{acl} having the negative (−) value. In this case, the front wheel torque command T_{f} has the negative (−) value as the regenerative braking torque command.

In an embodiment of the present disclosure, in the state in which the pedals are simultaneously applied by additionally applying the brake pedal in the state in which the accelerator pedal is applied, as determined in the operation S21, and when the pedal simultaneous application allowable condition in the regeneration-directivity reverse distribution state is satisfied as determined in the operation S22, the amount of the braking torque is sequentially reflected (the absolute value of the amount of braking torque is subtracted) in the torque command determined according to the set priority.

In other words, when the pedal simultaneous application allowable condition is satisfied in the state in which the pedals are simultaneously applied, in order to reflect the amount of the braking torque T_{brk} corresponding to the BPS value (amount of the applied brake pedal) in the torque command, the amount of the braking torque T_{brk} having the negative (−) value is reflected by being added to the torque command determined according to the following priority (i.e., the absolute value of the amount of the braking torque is subtracted).

In an operation S27, the amount of the braking torque T_{brk} is first added to the front wheel torque command T_{f} according to the set priority (see operation S27). In other words, this means that the absolute value of the amount of the braking torque is subtracted from the front wheel torque command having the negative (−) value.

In this case, the rear wheel torque command Tᵣ is determined to be a value obtained by subtracting the front wheel torque command (value before the amount of the braking torque is reflected) from the entire torque command T_{acl} corresponding to the APS value.

This is performed until it is determined, in an operation S28, the front wheel torque command after adding the amount of the braking torque T_{brk} (subtracting the absolute value of the amount of the braking torque) is larger than or equal to the front wheel alone regeneration limit value set as the negative (−) value in advance.

Here, the front wheel alone regeneration limit value is a limit value of the regenerative torque that may be generated by the front wheel motor in consideration of the limit of a regeneration distribution ratio between the front and rear wheels when only the front wheel motor generates the regenerative torque and is a value set in the controller 20 in advance.

When the front wheel torque command (T_{f}+T_{brk}) after adding the amount of the braking torque T_{brk} is larger than or equal to the front wheel alone regeneration limit value having the negative (−) value, the front wheel torque command after adding the amount of the braking torque T_{brk} is determined to be the front wheel torque command in which the amount of the braking torque is reflected. In this case, the amount of the braking torque is not reflected in the rear wheel torque command Tᵣ.

In other words, the entire torque command T_{acl} according to the APS value (amount of the applied accelerator pedal) is distributed to each of the front wheel torque command T_{f} having the negative (−) value and the rear wheel torque command Tᵣ having the positive (+) value, and when the brake pedal is additionally applied in the state in which the accelerator pedal is applied, the absolute value of the amount of the braking torque T_{brk} according to the BPS value is first subtracted from the front wheel torque command T_{f}, which is the distributed torque having the negative (−) value.

However, in an embodiment, when the front wheel torque command after adding the amount of the braking torque T_{brk} according to the BPS value is decreased to the front wheel alone regeneration limit value or less having the negative (−) value, the front wheel alone regeneration limit value, which is the negative (−) value, is determined to be the rear wheel torque command.

As described above, determining the front wheel alone regeneration limit value to be the front wheel torque command means that all of the amount of the braking torque T_{brk} are not yet reflected because a value obtained by adding some of the amount of the braking torque T_{brk} and the front wheel torque command Ti distributed from the entire torque command (subtracting the absolute value of some of the amount of the braking torque from the front wheel torque command T_{f}) is the front wheel offset torque T_{ofs,f}.

Therefore, when the front wheel torque command after adding the amount of the braking torque T_{brk} becomes smaller than the front wheel alone regeneration limit value, the front wheel alone regeneration limit value set to the negative (−) value is determined to be the front wheel torque command. In an operation S29, the remaining amount of the braking torque of the amount of the braking torque T_{brk}, which will be additionally reflected, is distributed according to the preset regeneration distribution ratio between the front and rear wheels.

In addition, in the operation S29, the amount of the front wheel regenerative braking torque (negative value) and the amount of the rear wheel regenerative braking torque (negative value) distributed according to the regeneration distribution ratio between the front and rear wheels are additionally reflected in each of the current front wheel torque command and rear wheel torque command (the absolute values of each of the amounts of the regenerative braking torque are subtracted from the front wheel torque command and the rear wheel torque command).

In order to secure vehicle attitude stability, an appropriate regenerative torque ratio between the front and rear wheels should be maintained. Thus, it is not possible to decrease only the front wheel torque command in a state in which the rear wheel torque command Tᵣ is maintained as the rear wheel offset torque T_{ofs,r}. Therefore, when the front wheel torque command becomes smaller than the front wheel alone regeneration limit value, a portion of the amount of the braking torque is reflected in the rear wheel torque command.

In this case, since the rear wheel torque command Tᵣ is in a state of being maintained as the rear wheel offset torque T_{ofs,r} having the positive (+) value and the amount of the distributed rear wheel regenerative braking torque has the negative (−) torque value, when the rear wheel torque command Tᵣ, which is the rear wheel offset torque T_{ofs,r}, is added to the amount of the rear wheel regenerative braking torque having the negative (−) value (i.e., when the absolute value of the amount of the rear wheel regenerative braking torque is subtracted), the rear wheel torque command enters the backlash band.

In this case, the rear wheel torque command should be decreased to the negative (−) torque region by passing through the backlash band while performing the zero-crossing. Accordingly, in the operation S29, while the rear wheel torque command passes through the backlash band, the backlash control of restricting the slope of the rear wheel torque command is performed.

In other words, the controller 20 determines the slope of the rear wheel torque command to be a value that smoothly varies along the preset maximum allowable slope while the rear wheel torque command passes through the backlash band. In this case, a torque following error caused by restricting the slope of the rear wheel torque command is compensated by generating an additional front wheel torque command in the regeneration direction or friction braking torque command as much as the following error.

In addition, upon finishing performing the zero-crossing and passing through backlash band, the additional generation of the front wheel torque command or the additional generation of the friction braking torque command for compensation may be re-released. In addition, upon finishing performing the zero-crossing and passing through the backlash band, as described above, the amount of the front wheel regenerative braking torque (negative value) and the amount of the rear wheel regenerative braking torque (negative value) to which the amount of the braking torque to be additionally reflected is distributed according to the regeneration distribution ratio between the front and rear wheels are reflected in the front wheel torque command and the rear wheel torque command.

In this case, the amount of the front wheel regenerative braking torque and the amount of the rear wheel regenerative braking torque having the negative (−) value are respectively added to the front wheel torque command and the rear wheel torque command. Since the absolute value of the front wheel regenerative braking torque is subtracted from the front wheel torque command and the amount of the rear wheel regenerative braking torque is subtracted from the rear wheel torque command, the magnitudes of the front wheel torque command and the rear wheel torque command vary in a direction in which the amount of regeneration increases.

In addition, since the front wheel torque command and the rear wheel torque command may not respectively exceed the preset front wheel maximum regeneration limit value and rear wheel maximum regeneration limit value, in operations S30 and S31, the friction braking device 50 may additionally generate the friction braking torque in order to compensate the insufficient amount of the braking torque when the front wheel torque command and the rear wheel torque command, which vary depending on the BPS value, respectively reach the front wheel maximum regeneration limit value and the rear wheel maximum regeneration limit value. Here, the front wheel maximum regeneration limit value and the rear wheel maximum regeneration limit value are maximum values of the amount of regeneration at which regeneration may be performed by the front wheel motor and are values set in the controller 20 in advance.

Then, when only the brake pedal is released in the state in which the application of the accelerator pedal is maintained, the reflection of the amount of the braking torque (i.e., adding the amount of the braking torque having the negative (−) value or subtracting the absolute value of the amount of the braking torque) is released in a reverse order of the priority.

In addition, thereafter, when the following error for the entire torque command is generated due to restricting the slope of the torque command passing through the backlash band when any one of the front wheel torque command and the rear wheel torque command performs zero-crossing from the regeneration direction to the driving direction and passes through the backlash band, the compensation may be performed as much as the following error using the other one to follow the entire torque command.

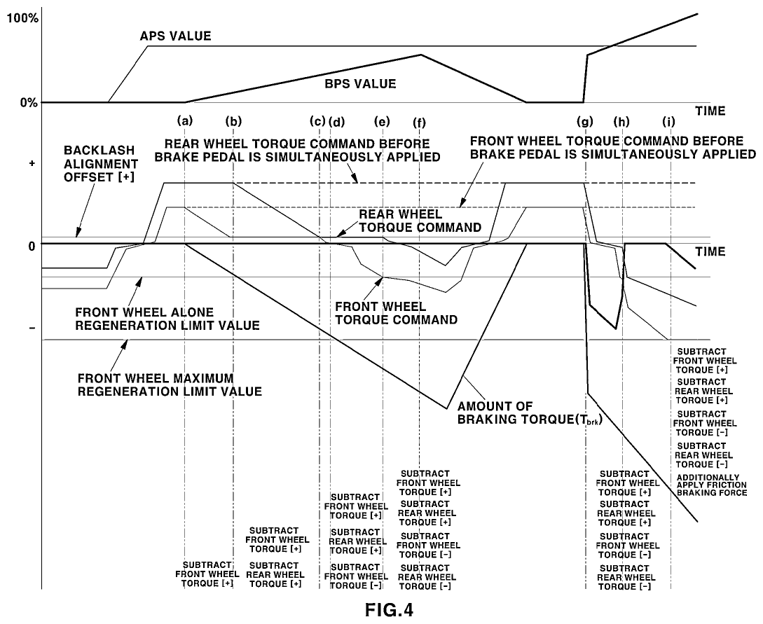

FIG. 4 is a view illustrating a torque control state, according to an embodiment of the present disclosure. FIG. 4 illustrates an example of the torque control state when the brake pedal is applied in the acceleration-directivity co-directional distribution mode to become a state in which the accelerator pedal and the brake pedal are simultaneously applied.

In FIG. 4, “subtracting the front wheel torque” means reflecting the amount of the braking torque in the front wheel torque command, and “subtracting the rear wheel torque” means reflecting the amount of the braking torque in the rear wheel torque command. Here, “subtracting” means reflecting the amount of the braking torque. Accordingly, “subtracting” means subtracting the absolute value of the amount of the braking torque and adding the amount of the braking torque having the negative (−) value.

As illustrated in FIG. 4, when only the accelerator pedal is applied, the entire torque command corresponding to the APS value (amount of the applied accelerator pedal) has the positive (+) torque value Further, when both the front wheel torque command and the rear wheel torque command for following the entire torque command have the positive (+) torque values, the torque control mode is the acceleration-directivity co-directional distribution mode.

A time point (a) is a time point at which the brake pedal is applied. When the brake pedal is additionally applied in the acceleration-directivity co-directional distribution state of the torque, the amount of the braking torque (absolute value of the amount of the braking torque) corresponding to the BPS value is first subtracted from the front wheel torque command from the time point at which the brake pedal is applied.

Subsequently, when the front wheel torque command reaches the front wheel offset torque set to the positive (+) torque value at a time point (b), the front wheel torque command maintains the front wheel offset torque value. Instead, the remaining amount of the braking torque (absolute value of the amount of the braking torque) is subtracted from the rear wheel torque command from the time point (b) reaching the front wheel offset torque value. Here, the remaining amount of the braking torque is the remaining amount of the braking torque excluding the amount of the braking torque subtracted from the front wheel torque command.

Subsequently, when the rear wheel torque command also reaches the rear wheel offset torque value at a time point (c), the remaining amount of the braking torque (absolute value of the amount of the braking torque) starts to be additionally re-subtracted from the front wheel torque command maintaining the front wheel offset torque value.

As described above, when the remaining amount of the braking torque (remaining amount of the braking torque not currently subtracted) starts to be additionally subtracted from the front wheel torque command at the time point (c), the front wheel torque command having the positive (+) value enters the backlash band at the time point (c) or around the time point (c), and subsequently, passes through the backlash band while performing zero-crossing at a time point (d).

While the front wheel torque command passes through the backlash band, the slope of the front wheel torque command is restricted. In this case, the following error for the entire torque command may be generated, and a responsiveness delay phenomenon due to the input of the brake pedal may occur.

Therefore, while the slope of the front wheel torque command is restricted to prevent the occurrence of this responsiveness delay phenomenon, the friction braking torque may be generated by the friction braking device 50 for compensation as much as the remaining braking torque not subtracted due to the restriction of the slope. In this case, the torque value of the rear wheel torque command is maintained as the rear wheel offset torque.

Subsequently, when the front wheel torque command finishes performing the zero-crossing and passing through the backlash band, the remaining amount of the braking torque (negative value) not reflected in the rear wheel torque command (maintained as the rear wheel offset torque) is continuously reflected in the front wheel torque command (the absolute value of the remaining amount of the braking torque is subtracted from the front wheel torque command).

In this case, in the example of FIG. 4, since the value of the applied braking pedal is increasing, the front wheel torque command is increased in the regeneration direction to meet the amount of the required braking torque. In other words, the absolute value of the front wheel torque command having the negative (−) torque value is increased.

Subsequently, when the front wheel torque command reaches the preset front wheel alone regeneration limit value at a time point (e), the remaining amount of the braking torque (absolute value of the amount of the braking torque) not reflected is subtracted from the rear wheel torque command maintained as the rear wheel offset torque value from this time point.

At this time, since the rear wheel torque command performs the zero-crossing and passes through the backlash band, the slope of the rear wheel torque command is restricted while the rear wheel torque command passes through the backlash band.

As described above, while the slope of the rear wheel torque command is restricted, the responsiveness delay phenomenon may occur. In order to prevent the responsiveness delay phenomenon, the remaining amount of the braking torque not reflected is distributed to the amount of the front wheel regenerative braking torque and the amount of the rear wheel regenerative braking torque according to the preset regeneration distribution ratio between the front and rear wheels. The amount of the distributed front wheel regenerative braking torque (negative value) and the amount of the distributed rear wheel regenerative braking torque (negative value) are then additionally reflected in the current front wheel torque command (negative value) and rear wheel torque command (negative value), respectively (the absolute values of the amount of the front wheel regenerative braking torque and the amount of the rear wheel regenerative braking torque are subtracted from the front and rear wheel torque commands).

Therefore, it is possible to increase the amounts of the regeneration of the front wheel and the rear wheel. In this case, the front wheel torque command having the negative (−) torque value is decreased to the front wheel alone regeneration limit value or less set to the negative (−) torque value (the absolute value of the front wheel torque command becomes larger than the absolute value of the front wheel alone regeneration limit value).

Here, the front wheel alone regeneration limit value is a limit value of the regenerative torque that may be generated by the front wheel motor in consideration of the limit of a regeneration distribution ratio between the front and rear wheels when only the front wheel motor generates the regenerative torque and is a value set in the controller 20 in advance.

Subsequently, when the rear wheel torque command finishes performing the zero-crossing and passing through the backlash band at a time point (f), the remaining amount of the braking torque is distributed according to the preset regeneration distribution ratio between the front and rear wheels to meet the amount of the required braking torque, and the front wheel torque command and the rear wheel torque command are increased in the regeneration direction as much as the amount of the distributed regeneration to follow the amount necessary for subtracting the torque.

Referring still to FIG. 4, a time point (g) is a time point at which, when the front wheel torque command and the rear wheel torque command have the positive (+) torque value again in the state in which the application of the brake pedal is released and then only the accelerator pedal is applied, the amount of the braking torque (absolute value of the amount of the braking torque) quickly increases.

In this case, since the amount of the braking torque (absolute value of the amount of the braking torque) should be rapidly subtracted, the amount of the braking torque should be subtracted starting from the torque command having the highest priority. The absolute value of the amount of the braking torque is subtracted from the front wheel torque command and the rear wheel torque command at substantially the same time.

In this case, both the front wheel torque command and the rear wheel torque command may pass through the backlash band. Thus, the friction braking torque is additionally applied to compensate the insufficient amount of the braking torque in order to prevent the responsiveness delay.

A time point (h) is a time point at which the front wheel torque command and the rear wheel torque command finish performing the zero-crossing and passing through the backlash band. At this time, the remaining amount of the braking torque is distributed according to the preset regeneration distribution ratio between the front and rear wheels to meet the amount of the required braking torque. Further, the torque values of the front wheel torque command and the rear wheel torque command are increased in the regeneration direction as much as the amount of the distributed regeneration to follow the amount necessary for subtracting the torque. In this case, the friction braking, applied to compensate the amount of the braking torque, is released.

A time point (i) is a time point at which the front wheel torque command reaches the preset front wheel maximum regeneration limit value, and the front wheel maximum regeneration limit value is determined to be the front wheel torque command from this time point. At this time, the insufficient amount of the braking torque compared to the required entire braking torque is compensated with the friction braking torque by the friction braking device 50 to follow the required torque.

The front wheel maximum regeneration limit value is a maximum value of the amount of the regeneration at which regeneration may be performed by the front wheel motor distinguished from the front wheel alone regeneration limit value, which is a limit value of the amount of the regeneration that may be performed by the front wheel motor when only the front wheel motor performs the regeneration operation, and a value separately set in the controller 20.

Although some embodiments of the present disclosure have been described above in detail, the scope of the present disclosure is not limited thereto. Rather, various modifications and improvements that may be made by those having ordinary skill in the art using the basic concept of the present disclosure defined in the appended claims are also included in the scope of the present disclosure.

What is claimed is:

1. A method of controlling a torque of a driving system of an electric vehicle, the method comprising:
determining, by a controller, whether a brake pedal is additionally applied at a time when only an acceleration pedal is applied;
determining, by the controller, an amount of a braking torque corresponding to an amount of the applied brake pedal when it is determined to be a pedal simultaneous application state in which the brake pedal is additionally applied;
reflecting, by the controller, the determined amount of the braking torque in one or both of a front wheel torque command and a rear wheel torque command selected according to information indicating a current vehicle driving state and front and rear wheel torque distribution states; and
controlling, according to the front wheel torque command and the rear wheel torque command determined by reflecting of the amount of the braking torque, a front wheel motor configured to drive a front wheel of the electric vehicle and a rear wheel motor configured to drive a rear wheel of the electric vehicle.

2. The method of claim 1, wherein the information indicating the current vehicle driving state and the front and rear wheel torque distribution states includes:
an entire torque command corresponding to an amount of the applied accelerator pedal when only the accelerator pedal is applied before the brake pedal is applied; and
the front wheel torque command and the rear wheel torque command distributed from the entire torque command when only the accelerator pedal is applied.

3. The method of claim 2, wherein, in an acceleration-directivity co-directional distribution state in which the entire torque command, when the accelerator pedal is applied before the brake pedal is applied, has a positive (+) torque value, and both the distributed front wheel torque command and rear wheel torque command have the positive (+) torque value, wherein the positive (+) torque value corresponds to an acceleration direction, reflecting the amount of the brake torque includes:
selecting the front wheel torque command; and
reflecting the amount of the braking torque first in the front wheel torque command.

4. The method of claim 3, further comprising, in the acceleration-directivity co-directional distribution state, when the front wheel torque command in which the amount of the braking torque is first reflected is smaller than a front wheel offset torque set to a positive (+) value:
determining, by the controller, the front wheel offset torque to be the front wheel torque command so that only a portion of the amount of the braking torque is reflected in the front wheel torque command; and
reflecting, by the controller, a remaining amount of the braking torque of the amount of the braking torque, which has not been reflected in the front wheel torque command, in the rear wheel torque command.

5. The method of claim 4, further comprising, when the rear wheel torque command in which the remaining amount of the braking torque has been reflected is smaller than a rear wheel offset torque set to the positive (+) value:
determining, by the controller, the rear wheel offset torque to be the rear wheel torque command so that only a portion of the remaining amount of the braking torque is reflected in the rear wheel torque command; and
additionally reflecting, by the controller, the remaining amount of the braking torque of the remaining amount of the braking torque, which has not been reflected in the rear wheel torque command, in the front wheel torque command having the front wheel offset torque value.

6. The method of claim 5, further comprising, when the front wheel torque command is changed by additionally reflecting the remaining amount of the braking torque in the front wheel torque command having the front wheel offset torque value, while the front wheel torque command passes through a preset backlash band while performing zero-crossing:
restricting, by the controller, a slope of the front wheel torque command to a preset maximum allowable slope; and
compensating, by the controller, a torque following error caused by restricting the slope of the front wheel torque command with a friction braking torque.

7. The method of claim 6, further comprising, when the front wheel torque command is changed by additionally reflecting the remaining amount of the braking torque in the front wheel torque command having the front wheel offset torque value, and when the front wheel torque command performs the zero-crossing and passes through the preset backlash band and then reaches a preset front wheel alone regeneration limit value:
distributing, by the controller, an amount of the braking torque of the amount of the braking torque, which has not yet been reflected, according to a preset regeneration distribution ratio between the front wheel and the rear wheel; and
reflecting, by the controller, the amount of the distributed front wheel regenerative braking torque and the amount of the distributed rear wheel regenerative braking torque, respectively, in a current front wheel torque command and a current rear wheel torque command.

8. The method of claim 7, further comprising, when the rear wheel torque command is changed by reflecting the amount of the rear wheel regenerative braking torque in the rear wheel torque command, while the rear wheel torque command passes through the preset backlash band while performing zero-crossing:
restricting, by the controller, a slope of the rear wheel torque command to the preset maximum allowable slope; and
compensating, by the controller, a torque following error caused by restricting the slope of the rear wheel torque command with the friction braking torque.

9. The method of claim 2, wherein, in a regeneration-directivity co-directional distribution state in which the entire torque command when only the accelerator pedal is applied has a negative (−) torque value and both the distributed front wheel torque command and rear wheel torque command have the negative (−) torque value, wherein the negative (−) torque value corresponds to a regeneration direction, reflecting the amount of the braking torque includes:
selecting the front wheel torque command; and
reflecting the amount of the braking torque first in the front wheel torque command.

10. The method of claim 9, further comprising, when the front wheel torque command in which the amount of the braking torque is reflected reaches a preset front wheel alone regeneration limit value:
distributing, by the controller, a remaining amount of the braking torque of the amount of the braking torque, which has not been reflected, according to a preset regeneration distribution ratio between the front wheel and the rear wheel; and
reflecting, by the controller, the amount of the distributed front wheel regenerative braking torque and the amount of the distributed rear wheel regenerative braking torque, respectively, in a current front wheel torque command and a current rear wheel torque command.

11. The method of claim 2, wherein, in an acceleration-directivity reverse distribution state in which i) the entire torque command when only the accelerator pedal is applied has a positive (+) torque value, ii) the distributed front wheel torque command has the negative (−) torque value, and the distributed rear wheel torque command has the positive (+) torque value, wherein the a positive (+) torque value corresponds to an acceleration direction and the negative (−) torque value corresponds to a regeneration direction, reflecting the amount of the braking torque includes:
selecting the rear wheel torque command; and
reflecting the amount of the braking torque first in the rear wheel torque command.

12. The method of claim 11, further comprising, when only the accelerator pedal is applied, in the acceleration-directivity reverse distribution state:
determining, by the controller, the front wheel torque command distributed from the entire torque command to be a value of a front wheel offset torque set to the negative (−) torque value; and
determining, by the controller, the rear wheel torque command to be a value obtained by subtracting the front wheel offset torque from the entire torque command when only the accelerator pedal is applied.

13. The method of claim 11, further comprising, in the acceleration-directivity reverse distribution state, when the rear wheel torque command in which the amount of the braking torque is first reflected is smaller than a rear wheel offset torque set to a positive (+) value:
determining, by the controller, the rear wheel offset torque to be the rear wheel torque command so that only a portion of the amount of the braking torque is reflected in the front wheel torque command; and
reflecting, by the controller, a remaining amount of the braking torque of the amount of the braking torque, which has not been reflected in the rear wheel torque command, in the front wheel torque command.

14. The method of claim 13, further comprising, when the front wheel torque command changed by reflecting the remaining amount of the braking torque reaches a preset front wheel alone regeneration limit value:
distributing, by the controller, an amount of the braking torque of the amount of the braking torque, which has not yet been reflected, according to a preset regeneration distribution ratio between the front wheel and the rear wheel; and
reflecting, by the controller, the amount of the distributed front wheel regenerative braking torque and the amount of the distributed rear wheel regenerative braking torque, respectively, in a current front wheel torque command and a current rear wheel torque command.

15. The method of claim 14, further comprising, when the rear wheel torque command is changed by reflecting the amount of the distributed rear wheel regenerative braking torque in the rear wheel torque command, while the rear wheel torque command passes through a preset backlash band while performing zero-crossing:
restricting, by the controller, a slope of the rear wheel torque command to a preset maximum allowable slope; and
compensating, by the controller, a torque following error caused by restricting the slope of the rear wheel torque command with a friction braking torque.

16. The method of claim 2, wherein, in a regeneration-directivity reverse distribution state in which i) the entire torque command when only the accelerator pedal is applied has a negative (−) torque value, ii) the distributed front wheel torque command has the negative (−) torque value, and iii) the distributed rear wheel torque command has a positive (+) torque value, wherein the positive (+) torque value corresponds to an acceleration direction and the negative (−) torque value corresponds to a regeneration direction, reflecting the amount of the braking torque includes:
selecting the front wheel torque command; and
reflecting the amount of the braking torque first in the front wheel torque command.

17. The method of claim 16, further comprising, when only the accelerator pedal is applied, in the regeneration-directivity reverse distribution state:
determining, by the controller, the rear wheel torque command distributed from the entire torque command to be a rear wheel offset torque value set to the positive (+) torque value; and
determining, by the controller, the front wheel torque command to be a value obtained by subtracting the rear wheel offset torque from the entire torque command when only the accelerator pedal is applied.

18. The method of claim 16, further comprising, when the front wheel torque command is changed by reflecting the amount of the braking torque reaches a preset front wheel alone regeneration limit value:
distributing, by the controller, an amount of the braking of the amount of the braking torque, which has not yet been reflected, according to a preset regeneration distribution ratio between the front wheel and the rear wheel; and
reflecting, by the controller, the amount of the distributed front wheel regenerative braking torque and the amount of the distributed rear wheel regenerative braking torque, respectively, in a current front wheel torque command and a current rear wheel torque command.

19. The method of claim 18, further comprising, when the rear wheel torque command is changed by reflecting the amount of the rear wheel regenerative braking torque in the rear wheel torque command, while the rear wheel torque command passes through a preset backlash band while performing zero-crossing:
restricting, by the controller, a slope of the rear wheel torque command to a preset maximum allowable slope; and
compensating, by the controller, a torque following error caused by restricting the slope of the rear wheel torque command with a friction braking torque.

20. The method of claim 1, further comprising, while the reflecting of the amount of the braking torque is performed:
compensating, by the controller, a remaining amount of the braking torque of the amount of the braking torque, which has not been reflected, with a friction braking torque when i) a portion of the amount of the braking torque is reflected in the front wheel torque command and the rear wheel torque command, and ii) the front wheel torque command and the rear wheel torque command in which the portion of the amount of the braking torque has been reflected reach, respectively, a preset front wheel maximum regeneration limit value and a preset rear wheel maximum regeneration limit value.
